(19) United States
(12) Patent Application Publication
(10) Pub. No.: US 2026/0323360 A1
(43) Pub. Date: Oct. 15, 2026

(54) QUALITY OF SERVICE (QoS) AND BEARER HANDLING FOR A MULTI-HOP RELAY NETWORK

(71) Applicant: QUALCOMM Incorporated, San Diego, CA (US)

(72) Inventors: Jianhua LIU, Beijing (CN); Karthika PALADUGU, Hyderabad (IN); Hong CHENG, Basking Ridge, NJ (US); Gavin Bernard HORN, La Jolla, CA (US)

(21) Appl. No.: 19/485,990

(22) PCT Filed: Jun. 17, 2023
(86) PCT No.: PCT/CN2023/100911

§ 371 Date: Nov. 19, 2025

(51) Int. Cl. H04W 28/02; H04L 47/10; H04W 88/04

(52) U.S. Cl. CPC H04W 28/0215; H04L 47/18; H04W 28/0205; H04W 28/0252; H04W 88/04

(57) ABSTRACT

A method for wireless communication at a first relay user equipment (UE) includes receiving a first message initiating a quality of service (QoS) flow for a remote UE associated with a multi-hop relay network that includes a group of UEs including at least the first relay UE, a second relay UE and the remote UE. The method also includes transmitting, to the second relay UE, in accordance with receiving the first message, first PC5 message indicating an E2E PC5 QoS profile, a modified E2E PC5 QoS profile, or the modified E2E PC5 QoS profile and the first per-hop QoS profile between the first relay UE and the second relay UE. The method further includes receiving, from the second relay UE, a second PC5 message that indicates a confirmation of receiving the first PC5 message.

### FIELD OF THE DISCLOSURE

The present disclosure relates generally to wireless communication, and more specifically to quality of service (QoS) and bearer handling for a multi-hop relay network.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunications standards to provide a common protocol that enables different wireless devices to communicate on a municipal, national, regional, and even global level. An example telecommunications standard is fifth generation (5G) new radio (NR). 5G NR is part of a continuous mobile broadband evolution promulgated by Third Generation Partnership Project (3GPP) to meet new requirements associated with latency, reliability, security, scalability (for example, with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the fourth generation (4G) long term evolution (LTE) standard. Narrowband (NB)-IoT and enhanced machine-type communications (eMTC) are a set of enhancements to LTE for machine type communications. There exists a need for further improvements in 5G NR technology. These improvements may also be applicable to other multi-access technologies and the telecommunications standards that employ these technologies.

Wireless communications systems may include or provide support for various types of communications, such as device-to-device (D2D) communications via a PC5 interface. The PC5 interface may also be referred to as a sidelink interface. In D2D communications, user equipment (UEs) may communicate with each other over a direct link (for example, PC5 link) instead of communicating with each other indirectly via an intermediary network node. In some examples, a group of UEs may form a multi-hop relay network using the PC5 interface. In some such examples, the group of UEs may communicate with a network node via a UE-to-network (U2N) relay, which may be one UE of the group of UEs. In some examples, the U2N relay may be an example of a proximity service (ProSe) U2N relay and the multi-hop relay network may be an example of a multi-U2N relay network.

### SUMMARY

In one aspect of the present disclosure, a method for wireless communication by a first relay user equipment (UE) includes receiving a first message initiating a quality of service (QoS) flow for a remote UE associated with a multi-hop relay network that includes a number of UEs including at least the first relay UE, a second relay UE and the remote UE. The multi-hop relay network facilitates communications between the remote UE and a network node. The method still further includes transmitting, to the second relay UE, in accordance with receiving the first message, a first PC5 message indicating an end-to-end (E2E) PC5 QoS profile between the remote UE and the first relay UE, a modified E2E PC5 QoS profile associated with splitting a first per-hop QoS profile between the first relay UE and the second relay UE from the E2E PC5 QoS profile, or the modified E2E PC5 QoS profile and the first per-hop QoS profile between the first relay UE and the second relay UE. The method also includes receiving, from the second relay UE, in accordance with transmitting the first PC5 message, a second PC5 message that indicates a confirmation of receiving the first PC5 message.

Another aspect of the present disclosure is directed to an apparatus including means for receiving a first message initiating a QoS flow for a remote UE associated with a multi-hop relay network that includes a number of UEs including at least the first relay UE, a second relay UE and the remote UE. The apparatus further includes means for transmitting, to the second relay UE, in accordance with receiving the first message, a first PC5 message indicating an end-to-end (E2E) PC5 QoS profile between the remote UE and the first relay UE, a modified E2E PC5QoS profile associated with splitting a first per-hop QoS profile between the first relay UE and the second relay UE from the E2E PC5 QoS profile, or the modified E2E PC5 QoS profile and the first per-hop QoS profile between the first relay UE and the second relay UE. The apparatus also includes means for receiving, from the second relay UE, in accordance with transmitting the first PC5 message, a second PC5 message that indicates a confirmation of receiving the first PC5 message.

In another aspect of the present disclosure, a non-transitory computer-readable medium with non-transitory program code recorded thereon is disclosed.

The program code is executed by a processor and includes program code to receive a first message initiating a QoS flow for a remote UE associated with a multi-hop relay network that includes a number of UEs including at least the first relay UE, a second relay UE and the remote UE. The program code still further includes program code to transmit, to the second relay UE, in accordance with receiving the first message, a first PC5 message indicating an end-to-end (E2E) PC5 QoS profile between the remote UE and the first relay UE, a modified E2E PC5 QoS profile associated with splitting a first per-hop QoS profile between the first relay UE and the second relay UE from the E2E PC5 QoS profile, or the modified E2E PC5 QoS profile and the first per-hop QoS profile between the first relay UE and the second relay UE. The program code also includes program code to receive, from the second relay UE, in accordance with transmitting the first PC5 message, a second PC5 message that indicates a confirmation of receiving the first PC5 message.

Another aspect of the present disclosure is directed to a first relay UE, including one or more processors, and one or more memories coupled with the one or more processors and storing processor-executable code that, when executed by the one or more processors, is configured to cause the first relay UE to receive a first message initiating a QoS flow for a remote UE associated with a multi-hop relay network that includes a number of UEs including at least the first relay UE, a second relay UE and the remote UE. The multi-hop relay network facilitates communications between the remote UE and a network node. Execution of the processor-executable code further causes the first relay UE to transmit, to the second relay UE, in accordance with receiving the first message a first PC5 message indicating an end-to-end (E2E) PC5 QoS profile between the remote UE and the first relay UE, a modified E2E PC5 QoS profile associated with splitting a first per-hop QoS profile between the first relay UE and the second relay UE from the E2E PC5 QoS profile, or the modified E2E PC5 QoS profile and the first per-hop QoS profile between the first relay UE and the second relay UE. Execution of the processor-executable code also causes the first relay UE to receive, from the second relay UE, in accordance with transmitting the first PC5 message, a second PC5 message that indicates a confirmation of receiving the first PC5 message In one aspect of the present disclosure, a method for wireless communication by a UE includes receiving, from a network node, a reconfiguration message indicating an E2E PC5 QoS profile for a multi-hop relay network that includes a number of UEs including at least the UE and a first relay UE. The method still further includes transmitting, to the first relay UE, in accordance with receiving the reconfiguration message, a first PC5 message indicating the E2E PC5 QoS profile, a modified E2E PC5 QoS profile associated with splitting a first per-hop QoS profile between the UE and the first relay UE from the E2E PC5 QoS profile, or the modified E2E PC5 QoS profile and the first per-hop QoS profile between the UE and the first relay UE. The method also includes receiving, from the first relay UE, in accordance with transmitting the first PC5 message, a second PC5 message that indicates a confirmation of receiving the first PC5 message.

Another aspect of the present disclosure is directed to an apparatus including means for receiving, from a network node, a reconfiguration message indicating an E2E PC5 QoS profile for a multi-hop relay network that includes a number of UEs including at least the UE and a first relay UE. The apparatus further includes means for transmitting, to the first relay UE, in accordance with receiving the reconfiguration message, a first PC5 message indicating the E2E PC5 QoS profile, a modified E2E PC5 QoS profile associated with splitting a first per-hop QoS profile between the UE and the first relay UE from the E2E PC5 QoS profile, or the modified E2E PC5 QoS profile and the first per-hop QoS profile between the UE and the first relay UE. The apparatus further includes means for receiving, from the first relay UE, in accordance with transmitting the first PC5 message, a second PC5 message that indicates a confirmation of receiving the first PC5 message.

In another aspect of the present disclosure, a non-transitory computer-readable medium with non-transitory program code recorded thereon is disclosed.

The program code is executed by a processor and includes program code to receive, from a network node, a reconfiguration message indicating an E2E PC5 QoS profile for a multi-hop relay network that includes a number of UEs including at least the UE and a first relay UE. The program code still further includes program code to transmit, to the first relay UE, in accordance with receiving the reconfiguration message, a first PC5 message indicating the E2E PC5 QoS profile, a modified E2E PC5 QoS profile associated with splitting a first per-hop QoS profile between the UE and the first relay UE from the E2E PC5 QoS profile, or the modified E2E PC5 QoS profile and the first per-hop QoS profile between the UE and the first relay UE. The program code also includes program code to receive, from the first relay UE, in accordance with transmitting the first PC5 message, a second PC5 message that indicates a confirmation of receiving the first PC5 message.

Another aspect of the present disclosure is directed to a UE, including one or more processors, and one or more memories coupled with the one or more processors and storing processor-executable code that, when executed by the one or more processors, is configured to cause the UE to receive, from a network node, a reconfiguration message indicating an E2E PC5 QoS profile for a multi-hop relay network that includes a number of UEs including at least the UE and a first relay UE. Execution of the processor-executable code further causes the first relay UE to transmit, to the first relay UE, in accordance with receiving the reconfiguration message, a first PC5 message indicating the E2E PC5 QoS profile, a modified E2E PC5 QoS profile associated with splitting a first per-hop QoS profile between the UE and the first relay UE from the E2E PC5 QoS profile, or the modified E2E PC5 QoS profile and the first per-hop QoS profile between the UE and the first relay UE. Execution of the processor-executable code also causes the first relay UE to receive, from the first relay UE, in accordance with transmitting the first PC5 message, a second PC5 message that indicates a confirmation of receiving the first PC5 message.

Aspects generally include a method, apparatus, system, computer program product, non-transitory computer-readable medium, user equipment, base station, wireless communications device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communications system and an access network.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a block diagram illustrating an example of a vehicle-to-everything (V2X) system, in accordance with various aspects of the present disclosure.

FIG. 5 is a block diagram illustrating an example of a sidelink (SL) communications scheme, in accordance with various aspects of the present disclosure.

FIG. 6 is a block diagram illustrating an example of a multi-hop UE-to-network (U2N) relay network, in accordance with various aspects of the present disclosure.

FIG. 7 is a timing diagram illustrating an example of configuring an end-to-end (E2E) QoS profile for a layer-3 (L3) multi-hop U2N relay network, in accordance with various aspects of the present disclosure.

FIG. 8 is a timing diagram illustrating an example of configuring an E2E QoS profile for a layer-2 (L2) multi-hop U2N relay network, in accordance with various aspects of the present disclosure.

FIG. 9 is a timing diagram illustrating an example of configuring an E2E dedicated radio bearer (DRB) configuration in a multi-hop U2N relay network, in accordance with various aspects of the present disclosure.

FIG. 10 is a timing diagram illustrating an example of configuring an E2E signaling radio bearer (SRB) configuration in a multi-hop U2N relay network, in accordance with various aspects of the present disclosure.

FIG. 11 is a block diagram illustrating an example wireless communication device that supports establishing a quality of service (QOS) profile for a multi-hop U2N relay network, in accordance with various aspects of the present disclosure.

FIGS. 12 and 13 are flow diagrams illustrating example processes for establishing a per-hop QoS profile for a multi-hop U2N relay network, for example, by a UE, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure disclosed, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology associated with 5G wireless technologies, aspects of the present disclosure can be applied in later generations, including 6G wireless technologies, or in other wireless communications systems.

In cellular communications networks, wireless devices may generally communicate with each other via access links with one or more network entities such as a base station or scheduling entity. Some cellular networks may also support device-to-device (D2D) communications that enable discovery of, and communications among, nearby devices using direct links, such as a PC5 interface, between devices (for example, without passing through a base station, relay, or other network entity). D2D communications may also be referred to as point-to-point (P2P) or sidelink communications. D2D communications may be implemented using licensed or unlicensed bands. Using D2D communications, devices can avoid some of the overhead that would otherwise be involved with routing to and from a network entity. D2D communications can also enable mesh networking and device-to-network relay functionality.

Sidelink (SL) communication is another example of D2D communication that uses a PC5 interface (also referred to as a sidelink interface) that enables a user equipment (UE) to communicate with another UE without tunneling through a base station and/or a core network. Sidelink communications can be communicated over a physical sidelink control channel (PSCCH) and a physical sidelink shared channel (PSSCH). The PSCCH and PSSCH are similar to a physical downlink control channel (PDCCH) and a physical downlink shared channel (PDSCH) in downlink (DL) communications between a base station and a UE. For instance, the PSCCH may carry sidelink control information (SCI) and the PSCCH may carry sidelink data (for example, user data). Each PSCCH is associated with a corresponding PSSCH, where SCI in a PSCCH may carry reservation and/or scheduling information for a sidelink data transmission in the associated PSSCH. Use cases for sidelink communications may include, among others, V2X, industrial Internet of Things (IoT) (IIoT), and/or NR-lite.

In some examples, a set of UEs may form a multi-hop relay network using the PC5 interface (hereinafter used interchangeably with sidelink interface). In such examples, a subset of UEs in the set of UEs may facilitate communications between a remote UE, in the set of UEs, and a network node. The set of UEs may include one or more UE-to-network (U2N) relays, which may be directly connected wirelessly with the network node. In some examples, each U2N relay may be a proximity service (ProSe) U2N relay (hereinafter used interchangeably with donor relay UE or donor UE) and the relay network is a multi-hop U2N relay network (hereinafter used interchangeably with multi-hop relay network).

In a typical multi-hop U2N relay network, a network node does not specify an end-to-end (E2E) bearer configuration that indicates an E2E PC5 quality-of-service (QoS) profile between a remote UE and a network node. A PC5 QoS profile may indicate one or more parameters or requirements, such as a minimum data rate and/or latency, such that communications between the remote UE and the network node satisfy one or more QoS thresholds. Failure to specify a PC5 QoS profile for the multi-hop U2N relay network may therefore reduce performance.

Various aspects of the present disclosure are directed to establishing an E2E bearer configuration that indicates an E2E PC5 QoS profile for a set of UEs in a multi-hop U2N relay network. The set of UEs includes one or more remote UEs and multiple relay UEs that facilitate communication between the remote UEs and a network node. Each relay UE may be a Layer 2 (L2) and/or Layer 3 (L3) relay UE. In some examples, the E2E PC5 QoS profile may be used to specify a per-hop PC5 QoS profile for each hop along the path to and from a remote UE and the network node in the multi-hop U2N relay network. Each hop represents or is associated with a respective link between a pair of adjacent UEs along the path. In some examples, a donor relay having a direct wireless communication link with the network node establishes the E2E PC5 QoS profile for the remote UE. In some other examples, the network node may establish the E2E PC5 QoS profile for the remote UE.

In examples in which a donor relay UE establishes an E2E PC5 QoS profile for a remote UE, the donor relay UE may receive, indirectly from the remote UE via relay by a subset of relay UEs, a first message that initiates a QoS flow associated with the remote UE. In some other examples, the donor relay UE may receive the first message from the network node. The QoS flow indicates one or more QoS parameters or requirements, such as bandwidth, latency, packet loss rate, throughput and/or priority for a data stream associated with the remote UE. The first message may originate at the remote UE in accordance with a PC5 setup procedure or a PC5 modification procedure initiated at the remote UE. In such examples, the donor relay UE then transmits, to the network node, and in accordance with receiving the first message, a second message indicating a hop count (that is, a number of hops) associated with a path between the remote UE and the network node via the subset of relay UEs of the multi-hop U2N relay network. The donor relay UE may then receive, from the network node, a third message indicating a QoS mapping that maps QOS parameters to the hops in the multi-hop U2N relay network in accordance with the hop count (in examples in which the donor relay receives the first message from the network node, the first message may also include the QoS mapping). The donor relay UE may determine the E2E PC5 QoS profile in accordance with the QoS mapping. The donor relay UE may then transmit, to a first relay UE of the subset of relay UEs along the path to the remote UE, a PC5 message indicating the E2E PC5 QoS profile, a modified E2E PC5 QoS profile associated with splitting a per-hop QoS profile between the donor relay UE and a first relay UE from the E2E PC5 QoS profile, or the modified E2E PC5 QoS profile and the per-hop QoS profile between the donor relay UE and the first relay UE. Each hop may be associated with a respective per-hop QoS profile that indicates QoS parameters for the hop between a respective pair of UEs. The pair of UEs associated with the hop may then actively adapt the QoS parameters according to network conditions and/or resource availability.

In examples in which the PC5 message transmitted from the donor relay UE to the first relay UE indicates the E2E PC5 profile, the first relay UE may split the E2E PC5 QoS profile established at the donor relay UE to determine a first per-hop PC5 profile, associated with a first hop between the first relay UE and the donor relay UE, and to determine a first modified E2E PC5 QoS profile associated with the remainder of the path between the first relay UE and the remote UE. In some such examples, the first relay UE may than transmit a modification acceptance message indicating the first per-hop QoS profile. The first relay UE may also transmit a PC5 message to either the remote UE (in instances in which the hop count is two) or to a second relay UE along the path to the remote UE (in instances in which the hop count is greater than two) that indicates the first modified E2E PC5 QoS profile. In some such examples, the second relay UE may split the first modified E2E PC5 QoS profile established at the first relay UE to determine a second per-hop PC5 profile, associated with a second hop between the second relay UE and the first relay UE, and to determine a second modified E2E PC5 QoS profile associated with the remainder of the path between the first relay UE and the remote UE The second relay UE may also transmit another PC5 message to either the remote UE (in instances in which the hop count is three) or to a third relay UE along the path to the remote UE (in instances in which the hop count is greater than three) that indicates the second modified E2E PC5 QoS profile. The process of splitting the remaining E2E PC5 QoS profile to determine a per-hop QoS profile may be repeated at other relay UEs until the remote UE is reached.

In some other examples in which the PC5 message transmitted from the donor relay UE to the first relay UE indicates the modified E2E QoS profile, or the modified E2E QoS profile and the per-hop QoS profile associated with the first hop between the first relay UE and the donor relay UE, it is the donor relay UE that splits the E2E PC5 QoS profile to determine the first per-hop QoS profile. In accordance with receiving the PC5 message, the first relay UE splits the modified E2E PC5 QoS profile determined at the donor relay UE to generate a second per-hop QoS profile associated with a second hop between the first relay UE and the remote UE (in instances in which the hop count is two) or a second relay UE along the path to the remote UE (in instances in which the hop count is greater than two). The process of splitting the remaining E2E PC5 QoS profile to determine a per-hop QoS profile may be repeated at other relay UEs until the remote UE is reached.

In examples in which the network node determines the E2E PC5 QoS profile, the network node may transmit, to a UE of the set of UEs associated with the multi-hop U2N relay network, a reconfiguration message indicating the E2E PC5 QoS profile. In such examples, the UE may be the donor relay UE or the remote UE. The donor relay UE or the remote UE may transmit, to a first relay UE of the set of relay UEs in accordance with receiving the reconfiguration message, a PC5 message indicating the E2E PC5 QoS profile or a first per-hop QoS profile associated with the E2E PC5 QoS profile. In examples in which the PC5 message transmitted from the donor relay UE or the remote UE to the first relay UE indicates the E2E PC5 profile, the first relay UE may split the E2E PC5 QoS profile determined at the network node to determine a first per-hop PC5 profile. This process is similar to the process described above with respect to the donor relay UE transmitting, to the first relay UE, the PC5 message indicating the E2E PC5 profile. In other examples, in which the PC5 indicates the first per-hop QoS profile associated with the E2E PC5 QoS profile determined at the network node, the donor relay UE or the remote UE splits the E2E PC5 QoS profile to determine the first per-hop QoS profile. This process is similar to the process described above with respect to the donor relay UE transmitting the PC5 message indicating the first per-hop QoS profile.

Particular aspects of the subject matter described in this disclosure can be implemented to realize one or more of the following potential advantages. In some examples, the described techniques for and including specifying a respective per-hop QoS profile for each hop associated with a path to/from a remote UE from/to a network node in a multi-hop U2N relay network may improve network reliability for each hop. For example, a first per-hop QoS profile associated with a first hop may specify a minimum data rate of 10 Mbps and a maximum latency of 50 milliseconds, and a second per-hop QoS profile associated with a second hop may specify a minimum data rate of 20 Mbps and a maximum latency of 30 milliseconds. Each per-hop QoS profile may vary based on network conditions and/or device capabilities at each hop. By configuring the respective per-hop QoS profiles, network conditions and/or device capabilities at each hop may be addressed individually without impacting overall network performance. This approach reduces a likelihood of packet loss, minimizes delays, and improves a reliability of a communication link at each hop. Improving the network reliability for each hop may improve the overall network reliability of the multi-hop U2N relay network, thereby improving communications between the remote UE and the network node.

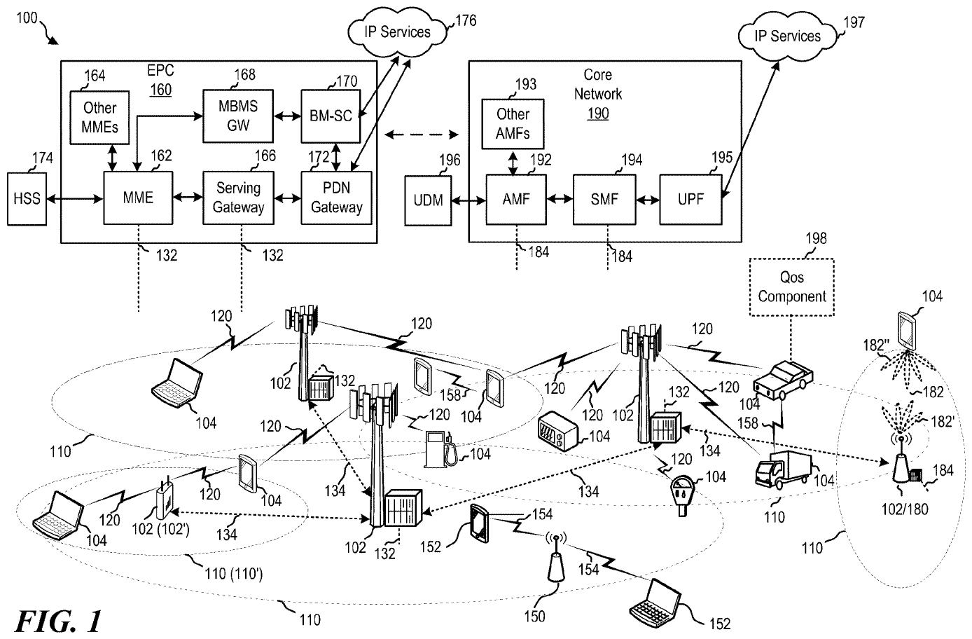

FIG. 1 is a diagram illustrating an example of a wireless communications system and an access network 100. The wireless communications system (also referred to as a wireless wide area network (WWAN)) includes base stations 102, UEs 104, an evolved packet core (EPC) 160, and another core network 190 (for example, a 5G core (5GC)). The base stations 102 may include macrocells (high power cellular base station) and/or small cells 102′ (low power cellular base station). The macrocells include base stations. The small cells 102′ include femtocells, picocells, and microcells.

The base stations 102 configured for 4G LTE (collectively referred to as evolved universal mobile telecommunications system (UMTS) terrestrial radio access network (E-UTRAN)) may interface with the EPC 160 through backhaul links 132 (for example, S1 interface). The base stations 102 configured for 5G NR (collectively referred to as next generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (for example, handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (for example, through the EPC 160 or core network 190) with each other over backhaul links 134 (for example, X2 interface). The backhaul links 134 may be wired or wireless.

The base stations 102 may wirelessly communicate with the UEs 104. Each of the base stations 102 may provide communications coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include home evolved Node Bs (eNBs) (HeNBs), which may provide service to a restricted group known as a closed subscriber group (CSG). The communications links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communications links 120 may use multiple-input and multiple-output (MIMO) antenna technology, including spatial multiplexing, beamforming, and/or transmit diversity. The communications links may be through one or more carriers. The base stations 102/UEs 104 may use spectrum up to Y MHz (for example, 5, 10, 15, 20, 100, 400, etc., MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (for example, more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communications link 158. The D2D communications link 158 may use the DL/UL WWAN spectrum. The D2D communications link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communications may be through a variety of wireless D2D communications systems, such as FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communications links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (for example, macro base station), may include a NR BS, a Node B, a 5G node B, an eNB, a gNodeB (gNB), an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC. Some base stations, such as gNB 180 may operate in a traditional sub 6 GHZ spectrum, in millimeter wave (mmWave) frequencies, and/or near mm Wave frequencies in communication with the UE 104. When the gNB 180 operates in mm Wave or near mmWave frequencies, the gNB 180 may be referred to as an mm Wave base station. Extremely high frequency (EHF) is part of the radio frequency (RF) in the electromagnetic spectrum. EHF has a range of 30 GHz to 300 GHz and a wavelength between 1 millimeter and 10 millimeters. Radio waves in the band may be referred to as a millimeter wave. Near mm Wave may extend down to a frequency of 3 GHz with a wavelength of 100 millimeters. The super high frequency (SHF) band extends between 3 GHz and 30 GHz, also referred to as centimeter wave. Communications using the mm Wave/near mm Wave radio frequency band (for example, 3 GHZ-300 GHz) has extremely high path loss and a short range. The mm Wave base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a mobility management entity (MME) 162, other MMEs 164, a serving gateway 166, a multimedia broadcast multicast service (MBMS) gateway 168, a broadcast multicast service center (BM-SC) 170, and a packet data network (PDN) gateway 172. The MME 162 may be in communication with a home subscriber server (HSS) 174. The MME 162 is the control node that processes the signaling between the UEs 104 and the EPC 160. Generally, the MME 162 provides bearer and connection management. All user Internet protocol (IP) packets are transferred through the serving gateway 166, which itself is connected to the PDN gateway 172. The PDN gateway 172 provides UE IP address allocation as well as other functions. The PDN gateway 172 and the BM-SC 170 are connected to the IP services 176. The IP services 176 may include the Internet, an intranet, an IP multimedia subsystem (IMS), a PS streaming service, and/or other IP services. The BM-SC 170 may provide functions for MBMS user service provisioning and delivery. The BM-SC 170 may serve as an entry point for content provider MBMS transmission, may be used to authorize and initiate MBMS bearer services within a public land mobile network (PLMN), and may be used to schedule MBMS transmissions. The MBMS gateway 168 may be used to distribute MBMS traffic to the base stations 102 belonging to a multicast broadcast single frequency network (MBSFN) area broadcasting a particular service, and may be responsible for session management (start/stop) and for collecting eMBMS related charging information.

The core network 190 may include an access and mobility management function (AMF) 192, other AMFs 193, a session management function (SMF) 194, and a user plane function (UPF) 195. The AMF 192 may be in communication with a unified data management (UDM) 196. The AMF 192 is the control node that processes the signaling between the UEs 104 and the core network 190. Generally, the AMF 192 provides quality of service (QOS) flow and session management. All user Internet protocol (IP) packets are transferred through the UPF 195. The UPF 195 provides UE IP address allocation as well as other functions. The UPF 195 is connected to the IP services 197. The IP services 197 may include the Internet, an intranet, an IP multimedia subsystem (IMS), a PS streaming service, and/or other IP services.

The base station 102 may also be referred to as a gNB, Node B, evolved Node B (eNB), an access point, a base transceiver station, a radio base station, a radio transceiver, a transceiver function, a basic service set (BSS), an extended service set (ESS), a transmit and receive point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (for example, MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (for example, a parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

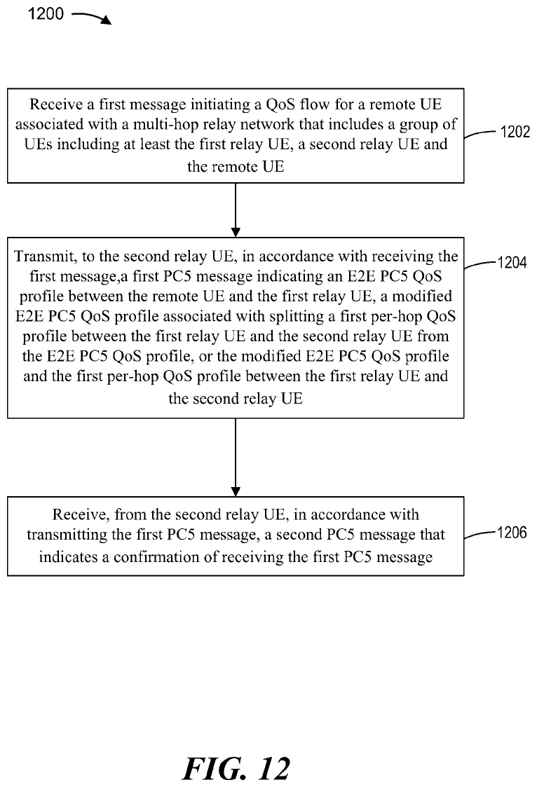

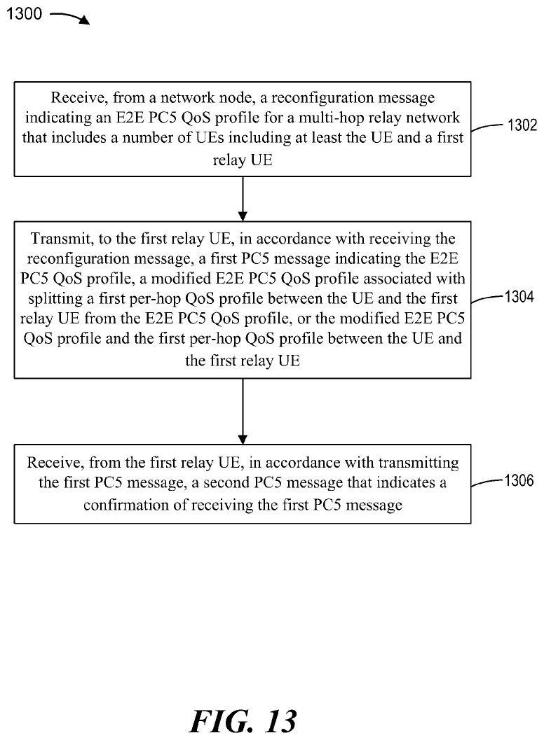

Referring again to FIG. 1, in certain aspects, a receiving device, such as the UE 104, may receive sensing information from one or more other UEs 104. The UE 104 that received the sensing information may also obtain sensing information from its own measurements. The UE 104 may include a QoS component 198 configured to perform one or more steps, such as one or more of the steps described with respect to the process 1200 and/or the process 1300 described with respect to FIGS. 12 and 13, respectively.

Although the following description may be focused on 5G NR, it may be applicable to other similar areas, such as LTE, LTE-A, CDMA, GSM, and other wireless technologies.

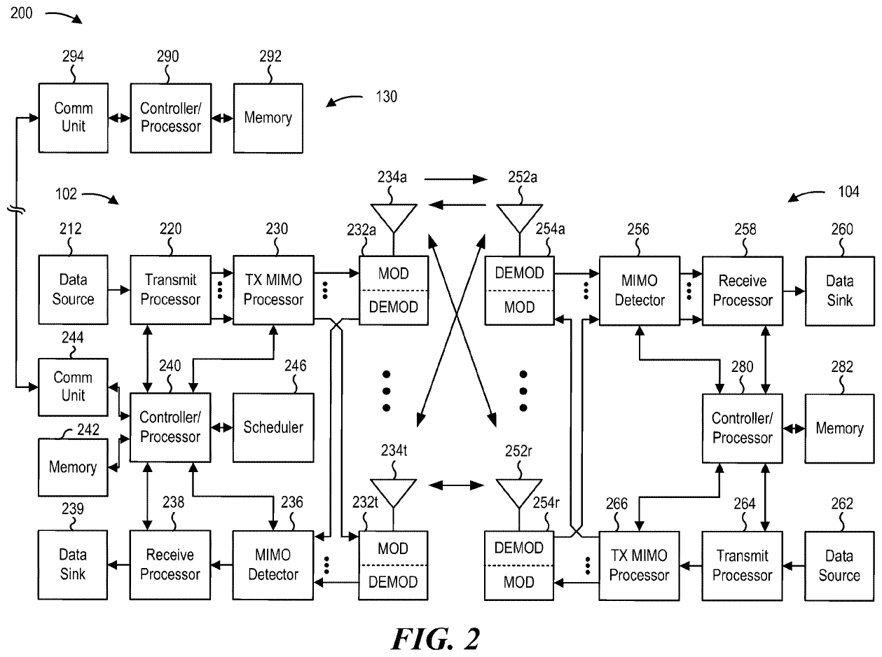

FIG. 2 shows a block diagram of a design 200 of the base station 102 and UE 104, which may be one of the base stations and one of the UEs in FIG. 1, respectively. The base station 102 may be equipped with T antennas 234a through 234t, and UE 104 may be equipped with R antennas 252a through 252r, where in general T≥1 and R≥1.

At the base station 102, a transmit processor 220 may receive data from a data source 212 for one or more UEs, select one or more modulation and coding schemes (MCS) for each UE based at least in part on channel quality indicators (CQIs) received from the UE, process (for example, encode and modulate) the data for each UE based at least in part on the MCS(s) selected for the UE, and provide data symbols for all UEs. Decreasing the MCS lowers throughput but increases reliability of the transmission. The transmit processor 220 may also process system information (for example, for semi-static resource partitioning information (SRPI) and/or the like) and control information (for example, CQI requests, grants, upper layer signaling, and/or the like) and provide overhead symbols and control symbols. The transmit processor 220 may also generate reference symbols for reference signals (for example, the cell-specific reference signal (CRS)) and synchronization signals (for example, the primary synchronization signal (PSS) and secondary synchronization signal (SSS)). A transmit (TX) multiple-input multiple-output (MIMO) processor 230 may perform spatial processing (for example, precoding) on the data symbols, the control symbols, the overhead symbols, and/or the reference symbols, if applicable, and may provide T output symbol streams to T modulators (MODs) 232a through 232t. Each modulator 232 may process a respective output symbol stream (for example, for orthogonal frequency division multiplexing (OFDM) and/or the like) to obtain an output sample stream. Each modulator 232 may further process (for example, convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 104, antennas 252a through 252r may receive the downlink signals from the base station 102 and/or other base stations and may provide received signals to demodulators (DEMODs) 254a through 254r, respectively. Each demodulator 254 may condition (for example, filter, amplify, downconvert, and digitize) a received signal to obtain input samples. Each demodulator 254 may further process the input samples (for example, for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (for example, demodulate and decode) the detected symbols, provide decoded data for the UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 104 may be included in a housing.

On the uplink, at the UE 104, a transmit processor 264 may receive and process data from a data source 262 and control information (for example, for reports comprising RSRP, RSSI, RSRQ, CQI, and/or the like) from the controller/processor 280. The transmit processor 264 may also generate reference symbols for one or more reference signals. The symbols from the transmit processor 264 may be precoded by a TX MIMO processor 266 if applicable, further processed by modulators 254a through 254r (for example, for discrete Fourier transform spread (DFT-s)-OFDM, CP-OFDM, and/or the like), and transmitted to the base station 102. At the base station 102, the uplink signals from the UE 104 and other UEs may be received by the antennas 234, processed by the demodulators 254, detected by a MIMO detector 236 if applicable, and further processed by a receive processor 238 to obtain decoded data and control information sent by the UE 104. The receive processor 238 may provide the decoded data to a data sink 239 and the decoded control information to a controller/processor 240. The base station 102 may include communications unit 244 and communicate to the core network 190 via the communications unit 244. The core network 190 may include a communications unit 294, a controller/processor 290, and a memory 292.

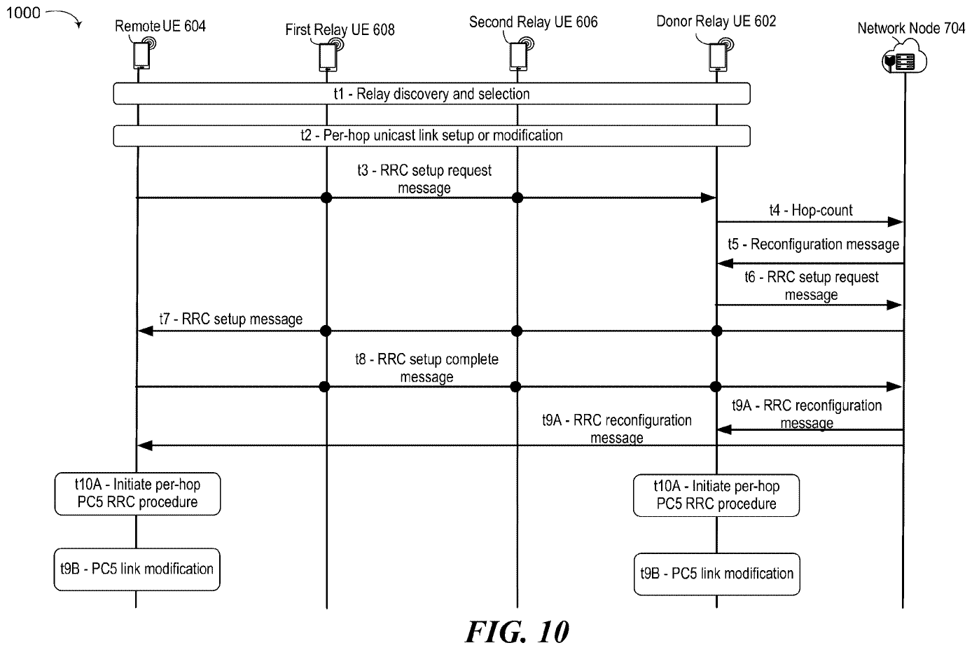

The controller/processor 240 of the base station 102, the controller/processor 280 of the UE 104, and/or any other component(s) of FIG. 2 may perform one or more techniques associated with configuring a relay-based sidelink network as described in more detail elsewhere. For example, the controller/processor 240 of the base station 102, the controller/processor 280 of the UE 104, and/or any other component(s) of FIG. 2 may perform or direct operations of, for example, the processes of FIGS. 10 and 12 and/or other processes as described. Memories 242 and 282 may store data and program codes for the base station 102 and UE 104, respectively. A scheduler 246 may schedule UEs for data transmission on the downlink and/or uplink.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture.

For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (for example, a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

At least one of the transmit processor 264, the receive processor 258, and the controller/processor 280 may be configured to perform aspects in connection with the QoS component 198.

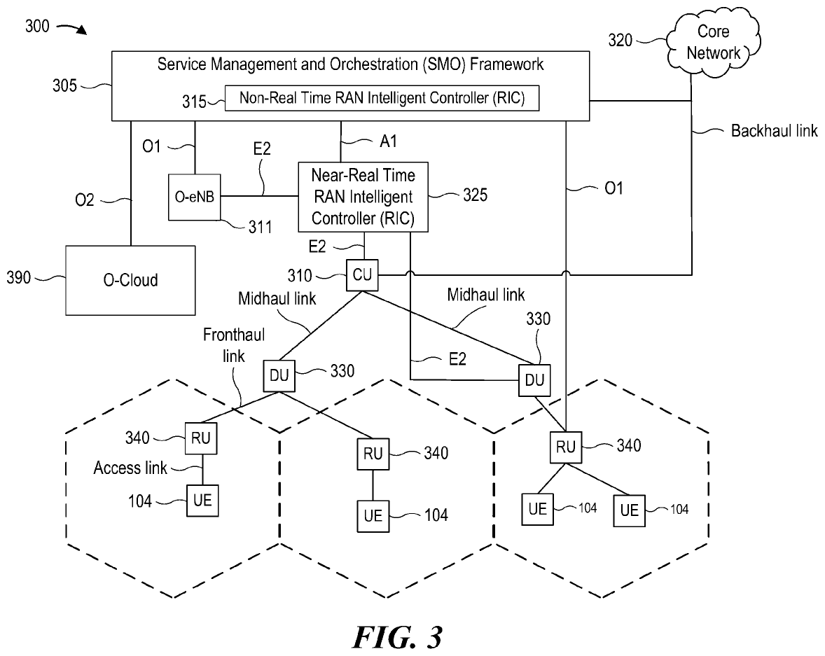

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units (for example, the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (for example, central unit-user plane (CU-UP)), control plane functionality (for example, central unit control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface.

Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an Al interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

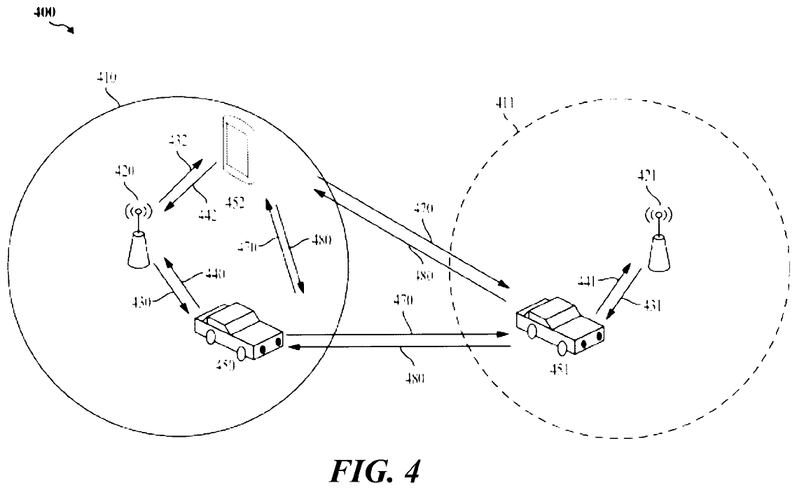

FIG. 4 is a diagram of a device-to-device (D2D) communications system 400, including V2X communications, in accordance with various aspects of the present disclosure. For example, the D2D communications system 400 may include V2X communications, (for example, a first UE 450 communicating with a second UE 451). In some aspects, the first UE 450 and/or the second UE 451 may be configured to communicate in a licensed radio frequency spectrum and/or a shared radio frequency spectrum. The shared radio frequency spectrum may be unlicensed, and therefore multiple different technologies may use the shared radio frequency spectrum for communications, including new radio (NR), LTE, LTE-Advanced, licensed assisted access (LAA), dedicated short range communications (DSRC), MuLTEFire, 4G, and the like. The foregoing list of technologies is to be regarded as illustrative, and is not meant to be exhaustive.

The D2D communications system 400 may use NR radio access technology. Of course, other radio access technologies, such as LTE radio access technology, may be used. In D2D communications (for example, V2X communications or vehicle-to-vehicle (V2V) communications), the UEs 450, 451 may be on networks of different mobile network operators (MNOs). Each of the networks may operate in its own radio frequency spectrum. For example, the air interface to a first UE 450 (for example, Uu interface) may be on one or more frequency bands different from the air interface of the second UE 451. The first UE 450 and the second UE 451 may communicate via a sidelink component carrier, for example, via the PC5 interface. In some examples, the MNOs may schedule sidelink communications between or among the UEs 450, 451 in licensed radio frequency spectrum and/or a shared radio frequency spectrum (for example, 5 GHz radio spectrum bands).

The shared radio frequency spectrum may be unlicensed, and therefore different technologies may use the shared radio frequency spectrum for communications. In some aspects, a D2D communications (for example, sidelink communications) between or among UEs 450, 451 is not scheduled by MNOs. The D2D communications system 400 may further include a third UE 452.

The third UE 452 may operate on the first network 410 (for example, of the first MNO) or another network, for example. The third UE 452 may be in D2D communications with the first UE 450 and/or second UE 451. The first base station 420 (for example, gNB) may communicate with the third UE 452 via a downlink (DL) carrier 432 and/or an uplink (UL) carrier 442. The DL communications may use various DL resources (for example, DL subframes and/or DL channels). The UL communications may be performed via the UL carrier 442 using various UL resources (for example, UL subframes and/or UL channels).

The first network 410 operates in a first frequency spectrum and includes the first base station 420 (for example, gNB) communicating at least with the first UE 450, for example, as described in FIGS. 1-3. The first base station 420 (for example, gNB) may communicate with the first UE 450 via a DL carrier 430 and/or an UL carrier 440. The DL communications may use various DL resources (for example, DL subframes and/or DL channels). The UL communications may be performed via the UL carrier 440 using various UL resources (for example, UL subframes and/or UL channels).

In some aspects, the second UE 451 may be on a different network from the first UE 450. In some aspects, the second UE 451 may be on a second network 411 (for example, of the second MNO). The second network 411 may operate in a second frequency spectrum (for example, a second frequency spectrum different from the first frequency spectrum) and may include the second base station 421 (for example, gNB) communicating with the second UE 451, for example, as described in FIGS. 1-3.

The second base station 421 may communicate with the second UE 451 via a DL carrier 431 and an UL carrier 441. The DL communications are performed via the DL carrier 431 using various DL resources (for example, DL subframes and/or DL channels). The UL communications are performed via the UL carrier 441 using various UL resources (for example, UL subframes and/or UL channels).

In conventional systems, the first base station 420 and/or the second base station 421 assign resources to the UEs for device-to-device (D2D) communications (for example, V2X communications and/or V2V communications). For example, the resources may be a pool of UL resources, both orthogonal (for example, one or more frequency division multiplexing (FDM) channels) and non-orthogonal (for example, code division multiplexing (CDM)/resource spread multiple access (RSMA) in each channel). The first base station 420 and/or the second base station 421 may configure the resources via the PDCCH (for example, faster approach) or RRC (for example, slower approach).

In some systems, each UE 450, 451 autonomously selects resources for D2D communications. For example, each UE 450, 451 may sense and analyze channel occupation during the sensing window. The UEs 450, 451 may use the sensing information to select resources from the sensing window. As discussed, one UE 451 may assist another UE 450 in performing resource selection. The UE 451 providing assistance may be referred to as the receiver UE or partner UE, which may potentially notify the transmitter UE 450. The transmitter UE 450 may transmit information to the receiving UE 451 via sidelink communications.

The D2D communications (for example, V2X communications and/or V2V communications) may be carried out via one or more sidelink carriers 470, 480. The one or more sidelink carriers 470, 480 may include one or more channels, such as a physical sidelink broadcast channel (PSBCH), a physical sidelink discovery channel (PSDCH), a physical sidelink shared channel (PSSCH), and a physical sidelink control channel (PSCCH), for example.

In some examples, the sidelink carriers 470, 480 may operate using the PC5 interface. The first UE 450 may transmit to one or more (for example, multiple) devices, including to the second UE 451 via the first sidelink carrier 470. The second UE 451 may transmit to one or more (for example, multiple) devices, including to the first UE 450 via the second sidelink carrier 480.

In some aspects, the UL carrier 440 and the first sidelink carrier 470 may be aggregated to increase bandwidth. In some aspects, the first sidelink carrier 470 and/or the second sidelink carrier 480 may share the first frequency spectrum (with the first network 410) and/or share the second frequency spectrum (with the second network 411). In some aspects, the sidelink carriers 470, 480 may operate in an unlicensed/shared radio frequency spectrum.

In some aspects, sidelink communications on a sidelink carrier may occur between the first UE 450 and the second UE 451. In an aspect, the first UE 450 may perform sidelink communications with one or more (for example, multiple) devices, including the second UE 451 via the first sidelink carrier 470. For example, the first UE 450 may transmit a broadcast transmission via the first sidelink carrier 470 to the multiple devices (for example, the second and third UEs 451, 452). The second UE 451 (for example, among other UEs) may receive such broadcast transmission. Additionally, or alternatively, the first UE 450 may transmit a multicast transmission via the first sidelink carrier 470 to the multiple devices (for example, the second and third UEs 451, 452). The second UE 451 and/or the third UE 452 (for example, among other UEs) may receive such multicast transmission.

The multicast transmissions may be connectionless or connection-oriented. A multicast transmission may also be referred to as a groupcast transmission.

Furthermore, the first UE 450 may transmit a unicast transmission via the first sidelink carrier 470 to a device, such as the second UE 451. The second UE 451 (for example, among other UEs) may receive such unicast transmission.

Additionally, or alternatively, the second UE 451 may perform sidelink communications with one or more (for example, multiple) devices, including the first UE 450 via the second sidelink carrier 480. For example, the second UE 451 may transmit a broadcast transmission via the second sidelink carrier 480 to the multiple devices. The first UE 450 (for example, among other UEs) may receive such broadcast transmission.

In another example, the second UE 451 may transmit a multicast transmission via the second sidelink carrier 480 to the multiple devices (for example, the first and third UEs 450, 452). The first UE 450 and/or the third UE 452 (for example, among other UEs) may receive such multicast transmission. Further, the second UE 451 may transmit a unicast transmission via the second sidelink carrier 480 to a device, such as the first UE 450. The first UE 450 (for example, among other UEs) may receive such unicast transmission. The third UE 452 may communicate in a similar manner.

In some aspects, for example, such sidelink communications on a sidelink carrier between the first UE 450 and the second UE 451 may occur without having MNOs allocating resources (for example, one or more portions of a resource block (RB), slot, frequency band, and/or channel associated with a sidelink carrier 470, 480) for such communications and/or without scheduling such communications. Sidelink communications may include traffic communications (for example, data communications, control communications, paging communications and/or system information communications). Further, sidelink communications may include sidelink feedback communications associated with traffic communications (for example, a transmission of feedback information for previously received traffic communications). Sidelink communications may employ at least one sidelink communications structure having at least one feedback symbol. The feedback symbol of the sidelink communications structure may allot for any sidelink feedback information that may be communicated in the device-to-device (D2D) communications system 400 between devices (for example, a first UE 450, a second UE 451, and/or a third UE 452). As discussed, a UE may be a vehicle (for example, UE 450, 451), a mobile device (for example, 452), or another type of device. In some cases, a UE may be a special UE, such as a roadside unit (RSU).

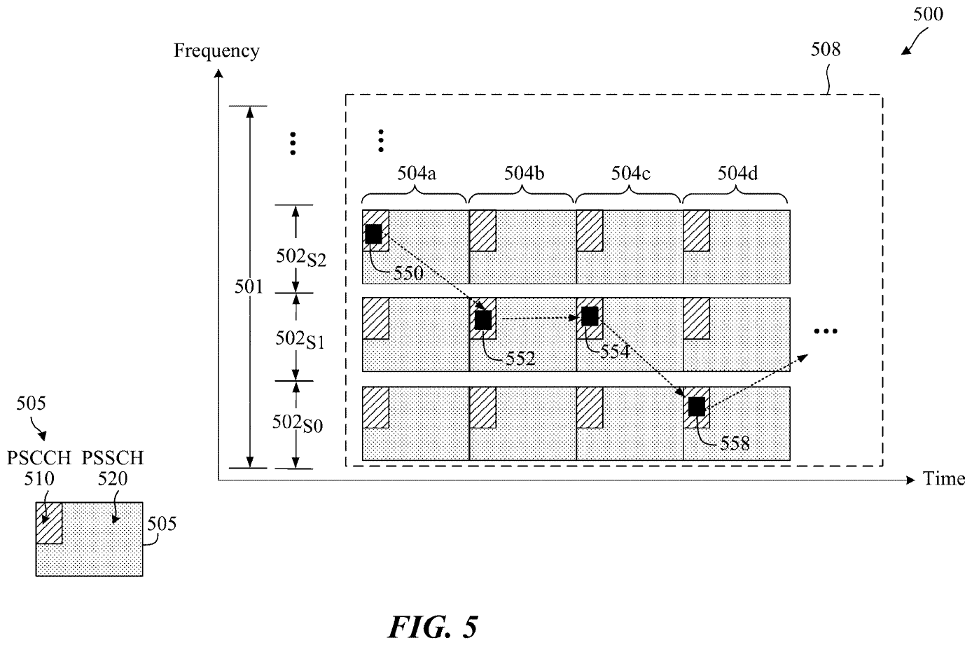

FIG. 5 is a graph illustrating a SL communications scheme, in accordance with various aspects of the present disclosure. A scheme 500 may be employed by UEs such as the UEs 104 in a network such as the network 100. In FIG. 5, the x-axis represents time and the y-axis represents frequency. In the scheme 500, a shared radio frequency band 501 is partitioned into multiple subchannels or frequency subbands 502 (shown as 502S0, 502S1, 502S2) in frequency and multiple sidelink frames 504 (shown as 504a, 504b, 504c, 504d) in time for sidelink communications. The frequency band 501 may be at any suitable frequencies. The frequency band 501 may have any suitable bandwidth (BW) and may be partitioned into any suitable number of frequency subbands 502. The number of frequency subbands 502 can be dependent on the sidelink communications BW requirement.

Each sidelink frame 504 includes a sidelink resource 505 in each frequency subband 502. A legend 505 indicates the types of sidelink channels within a sidelink resource 505. In some instances, a frequency gap or guard band may be specified between adjacent frequency subbands 502, for example, to mitigate adjacent band interference. The sidelink resource 505 may have a substantially similar structure as an NR sidelink resource. For instance, the sidelink resource 505 may include a number of subcarriers or RBs in frequency and a number of symbols in time. In some instances, the sidelink resource 505 may have a duration between about one millisecond (ms) to about 20 ms. Each sidelink resource 505 may include a PSCCH 510 and a PSSCH 520. The PSCCH 510 and the PSSCH 520 can be multiplexed in time and/or frequency. The PSCCH 510 may be for part one of a control channel (CCH), with the second part arriving as a part of the shared channel allocation. In the example of FIG. 5, for each sidelink resource 505, the PSCCH 510 is located during the beginning symbol(s) of the sidelink resource 505 and occupies a portion of a corresponding frequency subband 502, and the PSSCH 520 occupies the remaining time-frequency resources in the sidelink resource 505. In some instances, a sidelink resource 505 may also include a physical sidelink feedback channel (PSFCH), for example, located during the ending symbol(s) of the sidelink resource 505. In general, a PSCCH 510, a PSSCH 520, and/or a PSFCH may be multiplexed within a sidelink resource 505.

The PSCCH 510 may carry SCI 550 and/or sidelink data. The sidelink data can be of various forms and types depending on the sidelink application. For instance, when the sidelink application is a V2X application, the sidelink data may carry V2X data (for example, vehicle location information, traveling speed and/or direction, vehicle sensing measurements, etc.). Alternatively, when the sidelink application is an IIoT application, the sidelink data may carry IIoT data (for example, sensor measurements, device measurements, temperature readings, etc.). The PSFCH can be used for carrying feedback information, for example, HARQ ACK/NACK for sidelink data received in an earlier sidelink resource 505.

In an NR sidelink frame structure, the sidelink frames 504 in a resource pool 508 may be contiguous in time. A sidelink UE (for example, the UEs 104) may include, in SCI 550, a reservation for a sidelink resource 505 in a later sidelink frame 504. Thus, another sidelink UE (for example, a UE in the same NR-U sidelink system) may perform SCI sensing in the resource pool 508 to determine whether a sidelink resource 505 is available or occupied. For instance, if the sidelink UE detected SCI indicating a reservation for a sidelink resource 505, the sidelink UE may refrain from transmitting in the reserved sidelink resource 505. If the sidelink UE determines that there is no reservation detected for a sidelink resource 505, the sidelink UE may transmit in the sidelink resource 505. As such, SCI sensing can assist a UE in identifying a target frequency subband 502 to reserve for sidelink communications and to avoid intra-system collision with another sidelink UE in the NR sidelink system. In some aspects, the UE may be configured with a sensing window for SCI sensing or monitoring to reduce intra-system collision.

In some aspects, the sidelink UE may be configured with a frequency hopping pattern. In this regard, the sidelink UE may hop from one frequency subband 502 in one sidelink frame 504 to another frequency subband 502 in another sidelink frame 504. In the illustrated example of FIG. 5, during the sidelink frame 504a, the sidelink UE transmits SCI 550 in the sidelink resource 505 located in the frequency subband 502S2 to reserve a sidelink resource 505 in a next sidelink frame 504b located at the frequency subband 502S1. Similarly, during the sidelink frame 504b, the sidelink UE transmits SCI 552 in the sidelink resource 505 located in the frequency subband 502S1 to reserve a sidelink resource 505 in a next sidelink frame 504c located at the frequency subband 502S1. During the sidelink frame 504c, the sidelink UE transmits SCI 554 in the sidelink resource 505 located in the frequency subband 502S1 to reserve a sidelink resource 505 in a next sidelink frame 504d located at the frequency subband 502S0. During the sidelink frame 504d, the sidelink UE transmits SCI 558 in the sidelink resource 505 located in the frequency subband 502S0. The SCI 558 may reserve a sidelink resource 505 in a later sidelink frame 504.

The SCI can also indicate scheduling information and/or a destination identifier (ID) identifying a target receiving sidelink UE for the next sidelink resource 505. Thus, a sidelink UE may monitor SCI transmitted by other sidelink UEs. Upon detecting SCI in a sidelink resource 505, the sidelink UE may determine whether the sidelink UE is the target receiver based on the destination ID. If the sidelink UE is the target receiver, the sidelink UE may proceed to receive and decode the sidelink data indicated by the SCI. In some aspects, multiple sidelink UEs may simultaneously communicate sidelink data in a sidelink frame 504 in different frequency subband (for example, via frequency division multiplexing (FDM)). For instance, in the sidelink frame 504b, one pair of sidelink UEs may communicate sidelink data using a sidelink resource 505 in the frequency subband 502S2 while another pair of sidelink UEs may communicate sidelink data using a sidelink resource 505 in the frequency subband 502S1.

In some aspects, the scheme 500 is used for synchronous sidelink communications. That is, the sidelink UEs may be synchronized in time and are aligned in terms of symbol boundary, sidelink resource boundary (for example, the starting time of sidelink frames 504). The sidelink UEs may perform synchronization in a variety of forms, for example, based on sidelink synchronization signal blocks (SSBs) received from a sidelink UE and/or NR-U SSBs received from a base station (for example, the base station 102) while in-coverage of the base station. In some aspects, the sidelink UE may be preconfigured with the resource pool 508 in the frequency band 501, for example, while in coverage of a serving base station. The resource pool 508 may include a plurality of sidelink resources 505. The base station can configure the sidelink UE with a resource pool configuration indicating resources in the frequency band 501 and/or the subbands 502 and/or timing information associated with the sidelink frames 504. In some aspects, the scheme 500 includes mode-2 RRA (for example, supporting autonomous radio resource allocation (RRA) that can be used for out-of-coverage sidelink UEs or partial-coverage sidelink UEs).

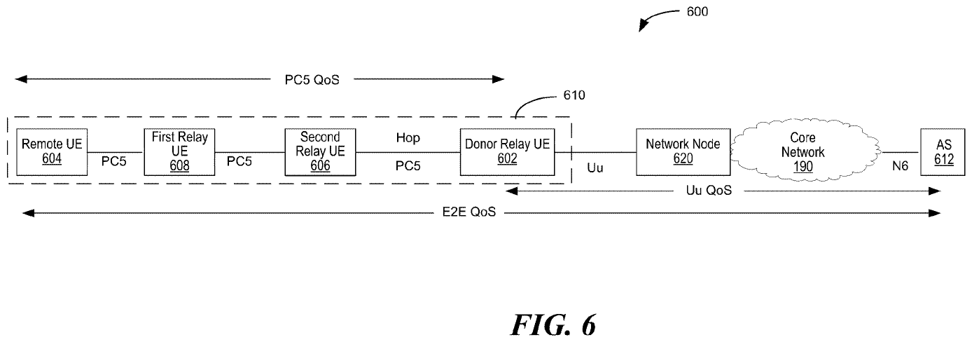

FIG. 6 is a block diagram illustrating an example of a multi-hop U2N relay network 600, in accordance with various aspects of the present disclosure. In the example of FIG. 6, a donor relay UE 602 is an example of ProSe U2N relay that acts as a relay between a network node 620 and a remote UE 604. Relay UEs 606 and 608 may facilitate communication between the donor relay UE 602 and the remote UE 604. For example, the donor relay UE 602 may act as an intermediary between the other UEs 604, 606, and 608 and the network node 620. The UEs 602, 604, 606, and 608 are associated with a multi-hop PC5 relay network 610. In the example of FIG. 6, each UE 602, 604, 606, and 608 may be an example of a UE 104 described with reference to FIGS. 1, 2, and 3, or a UE 450, 451, or 452 described with reference to FIG. 4. The UEs 602, 604, 606, and 608 may be L2 or L3 UEs. The network node 620 may be an example of a base station 102 described with reference to FIGS. 1 and 2, a CU 310, DU 330, or RU 340 described with reference to FIG. 3, or a base station 420 or 421 described with reference to FIG. 4.

In the example of FIG. 6, the donor relay UE 602 may be connected to the network node 620 via a Uu interface (for example, cellular interface). Therefore, the donor relay UE 602 can be in-coverage with respect to the network node 620.

The other UEs 604, 606, and 608 may be out-of-coverage. The other UEs 604, 606, and 608 may not be directly connected to the network node 620. Each UE 602, 604, 606, and 608 may be directly connected to a neighboring UE, via a PC5 interface.

The connection between two UEs may be referred to as a hop. The network node 620 may be associated with a core network 190, such as a 5G core (5GC) network or an evolved packet core (EPC) 160. Furthermore, the network node 620 may be connected to a public safety application server (AS) 612 via an N6 interface.

In the example of FIG. 6, the multi-hop PC5 relay network 610 may be associated with a PC5 QoS profile (also referred to as an end-to-end (E2E) PC5 QoS profile). Furthermore, the donor relay UE 602, network node 620, the core network 190, and the AS 612 may be associated with a Uu QoS profile. Furthermore, the multi-hop PC5 relay network 610, the donor relay UE 602, the network node 620, the core network 190, and the AS 612 may be associated with an E2E QoS profile. In a ProSe L3 network, such as a 5G ProSe L3 network, QoS specifications for relay traffic between a first UE (for example, remote UE 604) and the core network 190 (for example, UPF 195 of FIG. 1) may be satisfied via QoS controls. In some examples, the PC5 QoS manages the QoS for the PC5 link between the first relay UE 606 and the donor relay UE 602. The Uu QoS manages the QoS for a PDU session between the donor relay UE 602 and the core network 190. The PC5 QoS may be governed by one or more parameters, such as a packet QoS indicator (PQI), guaranteed flow bit rate (GFBR), maximum flow bit rate (MFBR), and/or a PC5 link aggregated maximum bit rate (AMBR). Similarly, the Uu QoS may be governed by one or more parameters, such as 5G QoS indicator (5QI), GFBR, and/or MFBR. QOS mapping may be preconfigured or provided to the U2N via a ProSe policy by the core network 190. In conventional systems, a ProSe L2 remote UE, such as the second relay UE 606, that connects to the network node 620 via a ProSe L2 U2N relay, such as the donor relay UE 602, may reuse existing 5G QoS controls. The core network 190 may receive QoS profiles from a session management function (SMF) associated with the ProSe L2 remote UE, and the network node 620 may configure the PC5 and Uu interfaces based on the QoS profiles to ensure proper QoS control.

Conventional systems do not provide an E2E bearer configuration in a multi-hop U2N relay network that specifies QoS parameters for communications between the group of UEs. The QoS parameters may include one or more of a data rate, delay, and reliability. Each hop of the multi-hop U2N relay network may be associated with a different QoS parameter. The failure to specify QoS parameters for the multi-hop U2N relay network may reduce network reliability for the communications between the group of UEs.

Various aspects of the present disclosure are directed to QoS handling and E2E bearer configuration for L2 and L3-based relay UEs in a multi-hop U2N relay network. In some examples, an E2E PC5 QoS profile may be specified for a L3 multi-hop U2N relay network. The E2E PC5 QoS profile may also be referred to as an E2E sidelink QoS profile. Specifically, PC5 may also be referred to as sidelink. In other examples, an E2E QoS profile may be specified for an L2 multi-hop U2N relay network. In other examples, an E2E dedicated radio bearer (DRB) configuration may be specified for a multi-hop U2N relay network. In other examples, an E2E signaling radio bearer (SRB) configuration may be specified for a multi-hop U2N relay network.

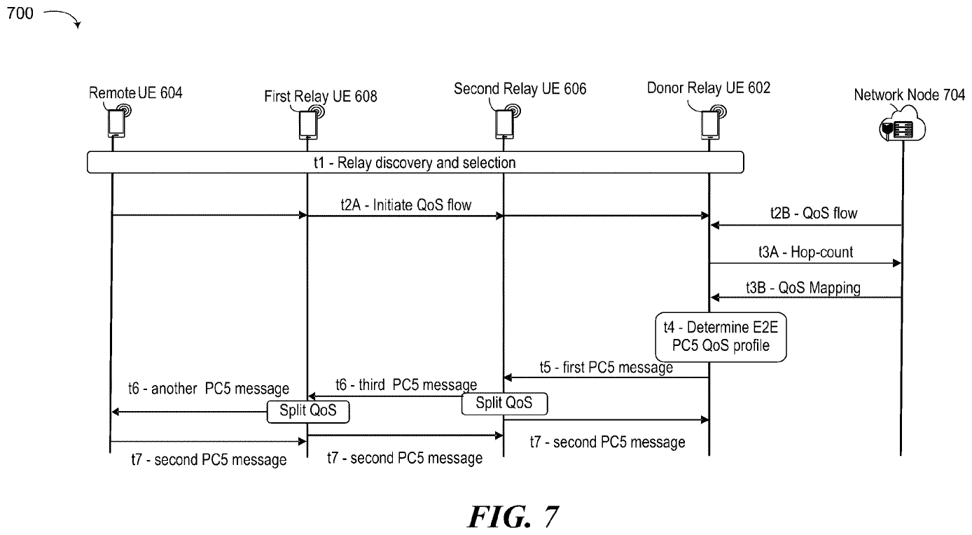

FIG. 7 is a timing diagram 700 illustrating an example of configuring an E2E QoS profile for an L3 multi-hop U2N relay network, in accordance with various aspects of the present disclosure. In the example of FIG. 7, an E2E PC5 QoS profile between a remote UE 604 and a donor relay UE 602 may be determined by the donor relay UE 602 or a network node 704. The E2E PC5 QoS profile may then be divided into a per-hop PC5 QoS profile. The remote UE 604 may be an example of a UE 104 described with reference to FIGS. 1, 2, and 3, or a UE 450, 451, or 452 described with reference to FIG. 4. In the example of FIG. 7, the network node 620 may be associated with a core network 190, such as 5GC network or an EPC 160. The L3 multi-hop U2N relay network is not limited to four UEs 602, 604, 606, and 608, as shown in the example of FIG. 7. The L3 multi-hop U2N relay network may include additional or fewer UEs between the remote UE 604 and the donor relay UE 602.

As shown in FIG. 7, at time t1, a relay discovery and selection process is performed by the remote UE 604, donor relay UE 602, second relay UE 606, and first relay UE 608. During the relay discovery and selection process, one or more of the UEs 602, 604, 606, and 608 identify one or more potential relays for the multi-hop U2N relay network. For example, the remote UE 604 may identify the second relay UE 606 and the first relay UE 608. As an example, the one or more potential relays may be identified via beaconing, where one or more of the UEs 602, 604, 606, and 608 periodically broadcast their presence. Additionally, or alternatively, the one or more potential relays may be identified based on exchanging control messages with neighboring UEs to determine if the neighboring UEs can act as relays. After identifying the potential relays, one or more of the potential relays may be selected based on various criteria, such as link quality, signal strength, and/or available resources. In response to the relay discovery and selection process, a per-hop PC5 unicast link may be established between neighboring UEs, as shown in the example of FIG. 7.

In an optional configuration, at time t2A, the remote UE 604 may initiate a QoS flow by forwarding E2E QoS parameters to the donor relay UE 602 using a per-hop PC5 link setup or modification procedure. The QoS flow initiated at time t2A may be associated with a sidelink link setup procedure or a sidelink link modification procedure. Alternatively, in some other examples, at time t2B, the network node 704 may transmit, to the donor relay UE 602, a message initiating the QoS flow. In such examples, the message transmitted at time t2B may also indicate a QoS mapping associated with the multi-hop network. The QoS flow of time t2B may be initiated by the SMF 194 (not shown in the example of FIG. 7). In some examples, the donor relay UE 602 either receives the QoS flow from the remote UE 604 at time t2A or from the network node 704 at time t2B.

In accordance with the remote UE 604 initiating the QoS flow (time t2A), at time t3A, the donor relay UE 602 may transmit, to the network node 620, a message indicating a hop-count (that is, a number of hops) associated with a path between the remote UE and the network node via the subset of relay UEs of the multi-hop U2N relay network. Based on receiving the hop-count, an SMF 194 may generate a more accurate 5QI and QoS mapping. At time t3B, the donor relay UE 602 may receive a message indicating a QoS mapping in accordance indicating the hop-count at time t3A. In some examples, prior to time t3A, the donor relay UE 602 may initiate a dynamic channel assignment (DCA) procedure (not shown in the example of FIG. 7). The DCA procedure may dynamically assign available channels to the UEs 602, 604, 606, and 608 in the multi-hop relay network based on current communication needs and/or available channel capacity.

At time t4, the donor relay UE 602 may determine the E2E PC5 QoS profile associated with the QoS flow initiated by the remote UE 604 (time t2A) or by the SMF 194 (time t2B). The E2E PC5 QoS profile may be a profile between the donor relay UE 602 and the remote UE 604. In some examples, the donor relay UE 602 may also determine a Uu QoS profile (for example, cellular QoS profile) at time t4. The Uu QoS profile may be determined in accordance with a conventional mechanism, such as a 3 GPP Rel-17 mechanism.

As shown in FIG. 7, at time t5, the donor relay UE 602 may transmit a first PC5 message, to a second relay UE 606, indicating an E2E PC5 QoS profile, a modified E2E PC5 QoS profile associated with splitting a first per-hop QoS profile between donor relay UE 602 and the second relay UE 606 from the E2E PC5 QoS profile, or the modified E2E PC5 QoS profile and the first per-hop QoS profile between the first relay UE and the second relay UE. The modified E2E PC5 QOS profile may be an E2E PC5 QoS profile between the remote UE 604 and the first relay UE 608 or the second relay UE 606. In some examples, based on the PC5 message indicating the E2E PC5 QoS profile, the second relay UE 606 divides the E2E PC5 QoS profile to generate a per-hop QoS profile for a PC5 hop between the second relay UE 606 and the donor relay UE 602. At time t6, the second relay UE 606 transmits, to the donor relay UE 602, a second PC5 message indicating a confirmation of receiving the first PC5 message. In some examples, in accordance with the first PC5 message indicating the E2E PC5 QoS profile, the second PC5 message may also indicate the per-hop QoS profile. Additionally, the second relay UE 606 may modify the E2E PC5 QoS profile and transmit, at time t7, the modified E2E PC5 QoS profile to a first relay UE 608 via a second PC5 message. The process described with respect to times t6 and t7 may be repeated at the first relay UE 608 and the remote UE 604.

In other examples, prior to transmitting the first PC5 message at time t5, the donor relay UE 602 may divide the E2E PC5 QoS profile to generate a per-hop QoS profile used for a first PC5 hop between the second relay UE 606 and the donor relay UE 602. Thus, in such examples, at time t5, the first PC5 message indicates first modified E2E PC5 QoS profile. The first modified E2E PC5 QoS profile refers to an E2E PC5 QoS profile that is generated after splitting the per-hop QoS profile from the initial E2E PC5 QoS profile determined at the donor relay UE 602. In some such examples, the first PC5 message may also indicate the per-hop QoS profile (for example, first per-hop QoS profile)determined at the donor relay UE 602. In accordance with receiving the PC5 message, the second relay UE 606 splits the modified E2E PC5 QoS profile to generate a second per-hop QoS profile associated with a PC5 hop between the first relay UE 608 and the second relay UE 606. In such examples, a third PC5 message transmitted at time t6 indicates the second per-hop QoS profile and a second E2E PC5 QoS profile. The process described with reference to time t6 may be repeated at the first relay UE 608. At time t7, the second relay UE 606 transmits a second PC5 message to the donor relay UE 602. The process described with reference to time t7 may be repeated at the first relay UE 608 and remote UE 604. The second PC5 message may include the per-hop QoS profile in accordance with the PC5 message indicating first modified E2E PC5 QoS profile. In other examples, the second PC5 message may not include the per-hop QoS profile if the PC5 message indicated the per-hop QoS profile. In yet another example, in accordance with the first PC5 message indicating a first per-hop QoS profile, the second PC5 message may indicate another per-hop QoS profile that is a modification of the first per-hop QoS profile. The modification may be performed at the second relay UE 606. The second PC5 message may also indicate a confirmation of receiving the first PC5 message.

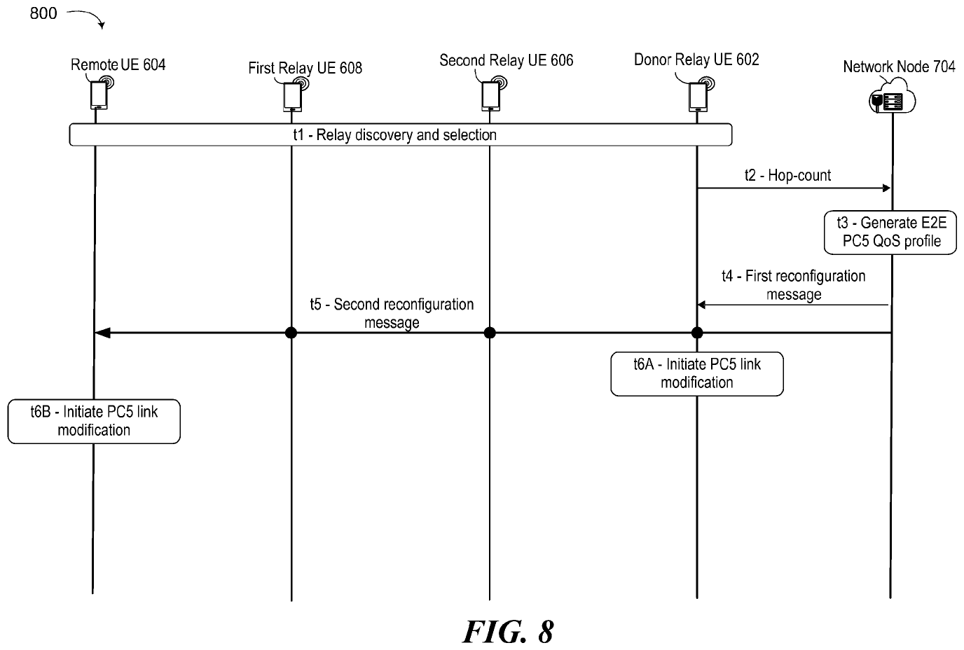

FIG. 8 is a timing diagram 800 illustrating an example of configuring an E2E QoS profile for an L2 multi-hop U2N relay network, in accordance with various aspects of the present disclosure. In the example of FIG. 8, an E2E PC5QoS profile between a remote UE 604 and a donor relay UE 602 may be determined by a network node 704. As shown in FIG. 8, at time t1, a relay discovery and selection process is performed by the remote UE 604, donor relay UE 602, second relay UE 606, and first relay UE 608. The relay discovery and selection process is similar to the relay discovery and selection process described with reference to FIG. 7. For brevity, details of the relay discovery and selection process are omitted from the description of FIG. 8.

In the example of FIG. 8, the remote UE 604 may establish an RRC connection with the network node 704, as well as the other UEs 602, 606, and 608. As shown in the example of FIG. 8, at time t2, the donor relay UE 602 transmits, to the network node 704, a sidelink information message (for example, a silelinkUEinformation message) indicating a hop-count associated with the L2 multi-hop U2N relay network. The hop-count may indicate a number of hops (for example, UEs) associated with the L2 multi-hop U2N relay network. In some examples, the sidelink information message may be an RRC message.

At time t3, the network node 704 generates an E2E PC5 QoS profile in accordance with receiving the hop-count. In some examples, the network node 704 may determine a QoS mapping in accordance with the hop-count. The E2E PC5 QoS profile may be determined based on the hop-count. In some examples, an E2E QoS profile may be determined based on the hop-count and the E2E QoS profile may be divided into the E2E PC5 QoS profile and a Uu QoS profile.

In some examples, at time t4, the network node 704 transmits, to the donor relay UE 602, a first reconfiguration message indicating the E2E PC5 QoS profile. The reconfiguration message may also include a Uu RLC channel configuration.

The Uu channel may be used for transmitting data between the donor relay UE 602 and the network node 704. The Uu RLC channel configuration may configure one or more of the following parameters: a channel ID of the Uu RLC channel; a QoS configuration of the Uu RLC channel; a mapping between a QoS flow and the Uu RLC channel; a QoS flow level QoS profile; a control plane traffic type; an RLC mode of the Uu RLC channel; or a bearer mapping configuration. The QoS flow may be associated with a set of QoS parameters that specify a level of service, which may differ based on a type of data being transmitted.

In such examples, at time t5, the network node 704 may transmit, to the remote UE 604 via the other UEs 602, 606, and 608, a second reconfiguration message indicating an E2E bearer configuration. The first and second reconfiguration messages may be RRC messages (for example, RRCReconfiguration messages). The E2E bearer configuration may configure one or more parameters, at each UE 602, 604, 606, and 608, to satisfy an E2E QoS flow. Furthermore, at time t6A, in response to receiving the first reconfiguration message indicating the E2E PC5 QoS profile, the donor relay UE 602 initiates a PC5 link modification procedure to divide the E2E PC5 QoS profile into a per-hop QoS profile. In some examples, the PC5 link modification procedure, at time t6A, may be similar to the procedure described with reference to times t5, t6, and t7 in FIG. 7.

In other examples, at time t4, the first reconfiguration message indicates the Uu RLC channel configuration. In such examples, at time t5, the second reconfiguration message indicates an E2E bearer configuration and the E2E PC5 QoS profile. The first and second reconfiguration messages may be RRC messages (for example, RRCReconfiguration messages). Furthermore, at time t6B, in response to receiving the second reconfiguration message indicating the E2E PC5 QoS profile, the remote UE 604 initiates a PC5 link modification procedure to divide the E2E PC5 QoS profile into a per-hop QoS profile. In some examples, the PC5 link modification procedure, at time t6A, may be similar to the procedure described with respect to times t5, t6, and t7 in FIG. 7. Still, in such examples, the remote UE 604 performs the process described with reference to the donor relay UE 602 at times t5, t6A, and t6B in FIG. 8. For example, the remote UE 604 may transmit the E2E PC5 QoS profile to the first relay UE 608 to cause the first relay UE 608 to split the E2E PC5 QoS profile. In other examples, the remote UE 604 may split the E2E PC5 QoS profile and transmit both the per-hop QoS profile and a modified E2E PC5 QoS profile to the first relay UE 608.

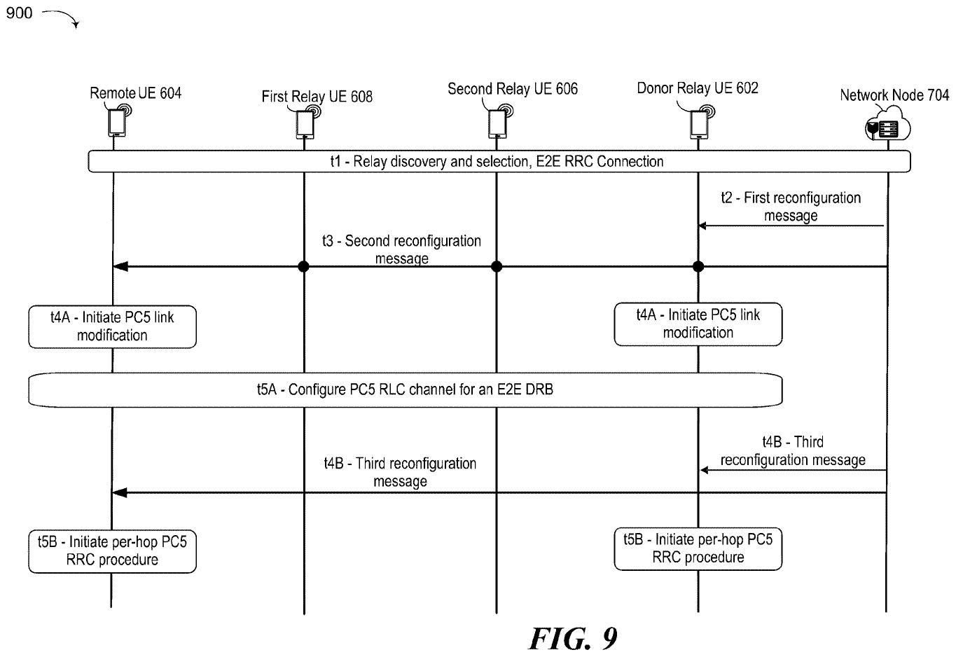

FIG. 9 is a timing diagram 900 illustrating an example of configuring an E2E DRB configuration in a multi-hop U2N relay network, in accordance with various aspects of the present disclosure. In the example of FIG. 9, at time t1, a relay discovery and selection process is performed by the remote UE 604, donor relay UE 602, second relay UE 606, and first relay UE 608. The relay discovery and selection process is similar to the relay discovery and selection process described with reference to FIG. 7. For brevity, details of the relay discovery and selection process are omitted from the description of FIG. 9. Additionally, at time t1, an E2E RRC connection may be established between the network node 704 and the remote UE 604.

At time t2, the network node 704 transmits, to the donor relay UE 602, a first reconfiguration message indicating a Uu RLC channel configuration for E2E DRBs, such as an L2 E2E DRB, in accordance with a Uu QoS profile. The Uu QoS profile may be split at the network node 704 from an E2E QoS profile. At time t3, the network node 704 may transmit, to the remote UE 604, a second reconfiguration message indicating an E2E bearer configuration including a service data adaptation protocol (SDAP) and a packet data convergence protocol (PDCP). The first and second reconfiguration messages may be RRC messages (for example, RRCReconfiguration messages).

In some examples, at time t4A, the remote UE 604 or the donor relay UE 602 may initiate a PC5 link modification procedure to determine a per-hop QoS profile. The PC5 link modification procedure may be similar to the PC5 link modification procedure described with reference to times t6A or t6B of FIG. 8. In such examples, at time t5A, after establishing a per-hop QoS profile, each pair of UEs sharing a hop may configure a PC5 RLC channel for an E2E DRB via a PC5 RRC message. The per-hop PC5 RLC channel may be configured in accordance with the per-hop QoS profile.

In other examples, at time t4B, the network node 704 transmits, to the remote UE 604 or the donor relay UE 602, a third reconfiguration message, such as an RRC reconfiguration message, indicating a per-hop PC5 RLC channel configuration for the E2E DRB. At time t5B, in response to receiving the third reconfiguration message, the remote UE 604 or the donor relay UE 602 initiates a per-hop PC5 RRC procedure to forward a per-hop PC5 RLC channel configuration for the E2E DRB to the other UEs, such as the second and first relay UEs 606 and 608, in the multi-hop relay network. The per-hop PC5 RLC channel configuration may be forwarded to the other UEs via a PC5 RRC message. In other examples, rather than using the per-hop PC5 RLC channel configuration received from the network node 704 at time t4B, a default per-hop PC5 RLC channel configuration may be used.

FIG. 10 is a timing diagram 1000 illustrating an example of configuring an E2E SRB configuration in a multi-hop U2N relay network, in accordance with various aspects of the present disclosure. In the example of FIG. 10, at time t1, a relay discovery and selection process is performed by the remote UE 604, donor relay UE 602, second relay UE 606, and first relay UE 608. The relay discovery and selection process is similar to the relay discovery and selection process described with reference to FIG. 7. For brevity, details of the relay discovery and selection process are omitted from the description of FIG. 10. Additionally, at time t2, a per-hop unicast link setup or modification procedure may be performed in accordance with the relay discovery and selection process of time t1. At time t3, the remote UE 604 transmits, to the other UEs 602, 606, and 608, an RRC setup request message indicating an SRB0 of the remote UE 604. The RRC setup request message may be transmitted via a default RLC channel configuration, such as SL-RLCO.

As shown in FIG. 10, in an optional configuration, at time t4, the donor relay UE 602 may transmit, to the network node 704, a sidelink UE information message indicating a hop-count of the multi-hop relay network. The sidelink UE information message may be an RRC message. At time t5, the network node 704 transmits, to the donor relay UE 602, an RRC reconfiguration message indicating a Uu RLC channel configuration for E2E SRBs. Additionally, the network node 704 transmits, to the remote UE 604, a reconfiguration message, such as an RRC reconfiguration message, indicating an E2E bearer configuration including an SDAP and a PDCP (not shown in the example of FIG. 10). At time t6, the donor relay UE 602 transmits, to the network node 704, the RRC setup request message received from the remote UE 604 at time t3. In response, at time t7, the network node 704, transmits to each UE 602, 604, 606, and 608 an RRC setup message. The RRC setup message may be transmitted via SL-RLC0. At time t8, the network node 704 may receive an RRC setup complete message, from the remote UE 604, via a per-hop RLC channel configuration for E2E SRB. The RLC channel configuration may be a default RLC channel configuration.

In some examples, in an optional configuration, at time t9A, the network node 704 transmits, to the remote UE 604 or the donor relay UE 602, a reconfiguration message, such as an RRC reconfiguration message, indicating a per-hop PC5 RLC channel configuration for the E2E SRB. At time t10A, in response to receiving the RRC reconfiguration message, the remote UE 604 or the donor relay UE 602 initiates a per-hop PC5 RRC procedure to forward a per-hop PC5 RLC channel configuration for the E2E SRB to the other UEs, such as the second and first relay UEs 606 and 608, in the multi-hop relay network. The per-hop PC5 RLC channel configuration may be forwarded to the other UEs via a PC5 RRC message. In other examples, rather than using the per-hop PC5 RLC channel configuration received from the network node 704 at time t9A, a default per-hop PC5 RLC channel configuration may be used.

In some other examples, at time t9B, the remote UE 604 or the donor relay UE 602 performs a PC5 link modification procedure to determine a per-hop QoS profile. The PC5 link modification procedure may be similar to the PC5 link modification procedure described with reference to times t6A or t6B of FIG. 8. In such examples, at time t10B, after establishing a per-hop QoS profile, each pair of UEs sharing a hop may configure a PC5 RLC channel for an E2E SRB via a PC5 RRC message. The per-hop PC5 RLC channel may be configured in accordance with the per-hop QoS profile.

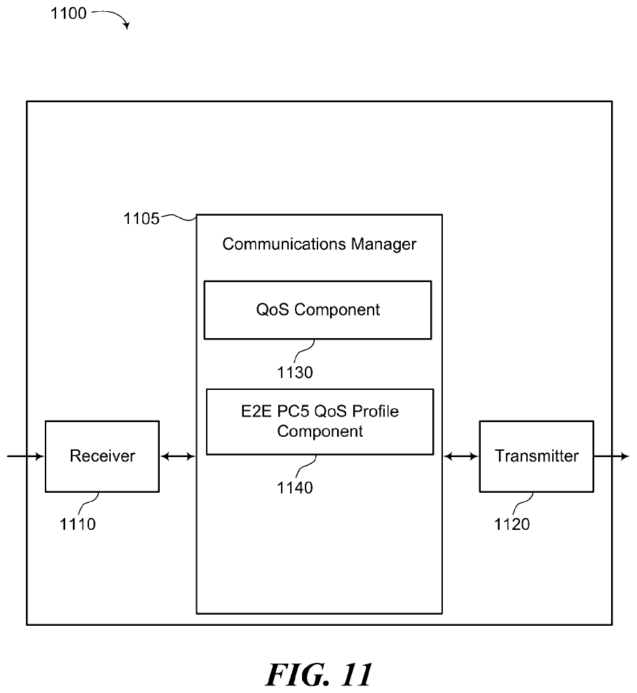

FIG. 11 is a block diagram illustrating an example wireless communication device 1100 that supports establishing a per-hop QoS profile for a multi-hop U2N relay network, in accordance with aspects of the present disclosure. The wireless communication device 1100 may be an example of aspects of a UE 104 described with reference to FIGS. 1, 2, and 3. a UE 450, 451, or 452 described with reference to FIG. 4, or a UE 602-608 as described with reference to FIGS. 6-10. The wireless communication device 1100 may include a receiver 1110, a communications manager 1105, a QoS component 1130, an E2E PC5 QoS profile component 1140, and a transmitter 1120, which may be in communication with one another (for example, via one or more buses). In some examples, the wireless communication device 1100 is configured to perform operations, including operations of the processes 1200-1500 described below with reference to FIGS. 11-15.

In some examples, the wireless communication device 1100 can include a chip, system on chip (SOC), chipset, package, or device that includes at least one processor and at least one modem (for example, a 5G modem or other cellular modem). In some examples, the communications manager 1105, or its sub-components, may be separate and distinct components. In some examples, at least some components of the communications manager 1105 are implemented at least in part as software stored in a memory. For example, portions of one or more of the components of the communications manager 1105 can be implemented as non-transitory code executable by the processor to perform the functions or operations of the respective component.

The receiver 1110 may receive one or more reference signals (for example, periodically configured CSI-RSs, aperiodically configured CSI-RSs, or multi-beam-specific reference signals), synchronization signals (for example, synchronization signal blocks (SSBs)), control information, and/or data information, such as in the form of packets, from one or more other wireless communication devices via various channels including control channels (for example, a PUCCH or a PSCCH) and data channels (for example, a PUSCH or a PSSCH). . . .

The received information may be passed on to other components of the wireless communication device 1100. The receiver 1110 may be an example of aspects of the receive processor 258 described with reference to FIG. 2. The receiver 1110 may include a set of radio frequency (RF) chains that are coupled with or otherwise utilize a set of antennas (for example, the set of antennas may be an example of aspects of the antennas 252 described with reference to FIG. 2).

The transmitter 1120 may transmit signals generated by the communications manager 1105 or other components of the wireless communication device 1100. In some examples, the transmitter 1120 may be collocated with the receiver 1110 in a transceiver. The transmitter 1120 may be an example of aspects of the transmit processor 264 described with reference to FIG. 2. The transmitter 1120 may be coupled with or otherwise utilize a set of antennas (for example, the set of antennas may be an example of aspects of the antennas 252), which may be antenna elements shared with the receiver 1110. In some examples, the transmitter 1120 is configured to transmit . . .

The communications manager 1105 may be an example of aspects of the controller/processor 280 described with reference to FIG. 2. The communications manager 1105 includes the QoS component 1130 and the E2E PC5 QoS profile component 1140. In some examples, working in conjunction with the receiver 1110, the QoS component 1130 receives a first message initiating a QoS flow for a remote UE associated with a multi-hop relay network that includes a group of UEs including at least the first relay UE, a second relay UE and the remote UE. In such examples, working in conjunction with the transmitter 1120 and/or the QoS component 1130, the E2E PC5 QoS profile component 1140 transmits, to the second relay UE, in accordance with receiving the first message, a first PC5 message indicating an end-to-end (E2E) PC5 QoS profile between the remote UE and the first relay UE, a modified E2E PC5 QoS profile associated with splitting a first per-hop QoS profile between the first relay UE and the second relay UE from the E2E PC5 QoS profile, or the modified E2E PC5 QoS profile and the first per-hop QoS profile between the first relay UE and the second relay UE. Working in conjunction with the receiver 1110, the QoS component 1130 receives, from the second relay UE, in accordance with transmitting the first PC5 message, a second PC5 message that indicates a confirmation of receiving the first PC5 message.

In some other examples, working in conjunction with the receiver 1110, the QoS component 1130 receives, from a network node, a reconfiguration message indicating an E2E PC5 QoS profile for a multi-hop relay network that includes a number of UEs including at least the UE and a first relay UE. In such examples, working in conjunction with the transmitter 1120 and/or the QoS component 1130, the E2E PC5 QoS profile component 1140 transmits, to the first relay UE, in accordance with receiving the reconfiguration message, a first PC5 message indicating the E2E PC5 QoS profile, a modified E2E PC5 QoS profile associated with splitting a first per-hop QoS profile between the UE and the first relay UE from the E2E PC5 QoS profile, or the modified E2E PC5 QoS profile and the first per-hop QoS profile between the UE and the first relay UE. Working in conjunction with the receiver 1110, the QoS component 1130 receives, from the first relay UE, in accordance with transmitting the first PC5 message, a second PC5 message that indicates a confirmation of receiving the first PC5 message.

FIG. 12 is a flow diagram illustrating an example process 1200 performed, for example, by a UE, in accordance with various aspects of the present disclosure. The example process 1200 is an example of establishing an E2E Pc5 QoS profile in a multi-hop relay network. The process 1200 begins at block 1202 by receiving a first message initiating a QoS flow for a remote UE associated with a multi-hop relay network that includes a group of UEs including at least the first relay UE, a second relay UE and the remote UE. The multi-hop relay network facilitating communications between the remote UE and a network node. At block 1204, the process 1200 transmits, to the second relay UE, in accordance with receiving the first message, a first PC5 message indicating an E2E PC5 QoS profile between the remote UE and the first relay UE, a modified E2E PC5 QoS profile associated with splitting a first per-hop QoS profile between the first relay UE and the second relay UE from the E2E PC5 QoS profile, or the modified E2E PC5 QoS profile and the first per-hop QoS profile between the first relay UE and the second relay UE. At block 1206, the process receives, from the second relay UE, in accordance with transmitting the first PC5 message, a second PC5 message that indicates a confirmation of receiving the first PC5 message.

FIG. 13 is a flow diagram illustrating an example process 1300 performed, for example, by a UE, in accordance with various aspects of the present disclosure. The example process 1300 is an example of establishing an E2E Pc5 QoS profile in a multi-hop relay network. As shown in the example of FIG. 13, the process 1300 begins at block 1302 by receiving, from a network node, a reconfiguration message indicating an E2E PC5 QoS profile for a multi-hop relay network that includes a number of UEs including at least the UE and a first relay UE. At block 1304, the process 1300 transmits, to the first relay UE, in accordance with receiving the reconfiguration message, a first PC5 message indicating the E2E PC5 QoS profile, a modified E2E PC5 QoS profile associated with splitting a first per-hop QoS profile between the UE and the first relay UE from the E2E PC5 QoS profile, or the modified E2E PC5 QoS profile and the first per-hop QoS profile between the UE and the first relay UE. At block 1306, the process 1300 receives, from the first relay UE, in accordance with transmitting the first PC5 message, a second PC5 message that indicates a confirmation of receiving the first PC5 message.

Implementation examples are described in the following numbered clauses:

Clause 1. A method for wireless communication by a first relay UE, comprising: receiving a first message initiating a QoS flow for a remote UE associated with a multi-hop relay network that includes a plurality of UEs including at least the first relay UE, a second relay UE and the remote UE, the multi-hop relay network facilitating communications between the remote UE and a network node; transmitting, to the second relay UE, in accordance with receiving the first message, a first PC5 message indicating an E2E PC5 QoS profile between the remote UE and the first relay UE, a modified E2E PC5 QoS profile associated with splitting a first per-hop QoS profile between the first relay UE and the second relay UE from the E2E PC5 QoS profile, or the modified E2E PC5 QoS profile and the first per-hop QoS profile between the first relay UE and the second relay UE; and receiving, from the second relay UE, in accordance with transmitting the first PC5 message, a second PC5 message that indicates a confirmation of receiving the first PC5 message.

Clause 2. The method of Clause 1, wherein: the first message is received via the second relay UE in accordance with a PC5 setup procedure or a PC5modification procedure originating at the remote UE; and the method further comprises: transmitting, to the network node, a second message indicating a hop count associated with the multi-hop network in accordance with receiving the first message; and receiving, from the network node, a third message indicating a QoS mapping in accordance with the hop count.

Clause 3. The method of Clause 2, further comprising determining the E2E PC5 QoS profile in accordance with the QoS mapping.

Clause 4. The method of Clause 1, wherein: the first message is received from the network node; the first message includes a QoS mapping associated with the multi-hop network; and the method further comprises determining the E2E PC5 QoS profile in accordance with the QoS mapping.

Clause 5. The method of any one of Clauses 1, wherein: the second PC5 message further indicates the first per-hop QoS profile in accordance with the first PC5 message indicating the E2E PC5 QoS profile; the first per-hop QoS profile indicates one or more QoS parameters associated with a hop between the first relay UE and the second relay UE.

Clause 6. The method of Clauses 1-4, further comprising: splitting the E2E PC5 QoS profile; and determining the modified E2E PC5 QoS profile associated with a path between the second relay UE and the remote UE in accordance with splitting the E2E PC5 QoS profile.

Clause 7. The method of Clause 6, wherein, in accordance with transmitting the first PC5 message, the modified E2E PC5 QoS profile causes the second relay UE to modify one or more QoS parameters associated with a hop between the second relay UE and the first relay UE.

Clause 8. The method of Clause 6, wherein the second PC5 message further indicates a second per-hop QoS profile between the first relay UE and the second relay UE in accordance with the first PC5 message indicating the modified E2E PC5 QoS profile and the first per-hop QoS profile.

Clause 9. The method of any one of Clauses 1-8, wherein each hop in the multi-hop network is associated with a respective per-hop QoS profile.

Clause 10. A method for wireless communication at a UE, comprising: receiving, from a network node, a reconfiguration message indicating an E2E PC5 QoS profile for a multi-hop relay network that includes a plurality of UEs including at least the UE and a first relay UE; transmitting, to the first relay UE, in accordance with receiving the reconfiguration message, a first PC5 message indicating the E2E PC5 QoS profile, a modified E2E PC5 QoS profile associated with splitting a first per-hop QoS profile between the UE and the first relay UE from the E2E PC5 QoS profile, or the modified E2E PC5 QoS profile and the first per-hop QoS profile between the UE and the first relay UE; and receiving, from the first relay UE, in accordance with transmitting the first PC5 message, a second PC5 message that indicates a confirmation of receiving the first PC5 message.

Clause 11. The method of Clause 10, further comprising: splitting the E2E PC5 QoS profile; and determining the modified E2E PC5 QoS profile associated with a path between the first relay UE and a remote UE, of the plurality of UEs, or a second relay UE, of the plurality of UEs, in accordance with splitting the E2E PC5 QoS profile.

Clause 12. The method of Clause 11, wherein, in accordance with transmitting the first PC5 message, the modified E2E PC5 QoS profile causes the first relay UE to modify one or more QoS parameters associated with a hop between the first relay UE and the UE.

Clause 13. The method of Clause 11, wherein the second PC5 message further indicates a second per-hop QoS profile between the first relay UE and the UE in accordance with the first PC5 message indicating the modified E2E PC5 QoS profile and the first per-hop QoS profile.

Clause 14. The method of Clause 11, further comprising transmitting, to the first relay UE, a third PC5 message indicating a per-hop PC5 RLC channel configuration associated with the first per-hop QoS profile.

Clause 15. The method of Clause 10, wherein: the second PC5 message further indicates the first per-hop QoS profile in accordance with the first PC5 message indicating the E2E PC5 QoS profile; and the first per-hop QoS profile indicates one or more QoS parameters associated with a hop between the first relay UE and the UE.

Clause 16. The method of any one of Clauses 10-15, wherein: the UE is a second relay UE of the plurality of UEs; and the reconfiguration message also indicates a cellular RLC channel configuration.

Clause 17. The method of any one of Clauses 10-16, wherein: the UE is a remote UE of the plurality of UEs; the reconfiguration message also indicates an E2E bearer configuration; and the multi-hop relay network facilitating communications between the remote UE and the network node.

Clause 18. The method of any one of Clauses 10-17, wherein: the reconfiguration message also indicates a per-hop PC5 RLC channel configuration for E2E DRBs; and the method further comprises transmitting, to the first relay UE, a third PC5 message indicating the per-hop PC5 RLC channel configuration for DRBs in accordance with receiving the reconfiguration message.

Clause 19. The method of any one of Clauses 10-17, wherein: the reconfiguration message also indicates a per-hop PC5 RLC channel configuration for E2E SRBs; and the method further comprises transmitting, to the first relay UE, a third PC5 message indicating the per-hop PC5 RLC channel configuration for SRBs in accordance with receiving the reconfiguration message.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code-it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example, a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (for example, related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

1. A method for wireless communication by a first relay user equipment (UE), comprising:
receiving a first message initiating a quality of service (QOS) flow for a remote UE associated with a multi-hop relay network that includes a plurality of UEs including at least the first relay UE, a second relay UE and the remote UE, the multi-hop relay network facilitating communications between the remote UE and a network node;
transmitting, to the second relay UE, in accordance with receiving the first message, a first PC5 message indicating an end-to-end (E2E) PC5 QoS profile between the remote UE and the first relay UE, a modified E2E PC5 QoS profile associated with splitting a first per-hop QoS profile between the first relay UE and the second relay UE from the E2E PC5 QoS profile, or the modified E2E PC5 QoS profile and the first per-hop QoS profile between the first relay UE and the second relay UE; and
receiving, from the second relay UE, in accordance with transmitting the first PC5message, a second PC5 message that indicates a confirmation of receiving the first PC5 message.

2. The method of claim 1, wherein:
the first message is received via the second relay UE in accordance with a PC5 setup procedure or a PC5 modification procedure originating at the remote UE; and
the method further comprises:
transmitting, to the network node, a second message indicating a hop count associated with the multi-hop network in accordance with receiving the first message; and
receiving, from the network node, a third message indicating a QOS mapping in accordance with the hop count.

3. The method of claim 2, further comprising determining the E2E PC5 QoS profile in accordance with the QOS mapping.

4. The method of claim 1, wherein:
the first message is received from the network node;
the first message includes a QoS mapping associated with the multi-hop network; and
the method further comprises determining the E2E PC5 QoS profile in accordance with the QOS mapping.

5. The method of claim 1, wherein:
the second PC5 message further indicates the first per-hop QoS profile in accordance with the first PC5 message indicating the E2E PC5 QoS profile;
the first per-hop QoS profile indicates one or more QoS parameters associated with a hop between the first relay UE and the second relay UE.

6. The method of claim 1, further comprising:
splitting the E2E PC5 QoS profile; and
determining the modified E2E PC5 QoS profile associated with a path between the second relay UE and the remote UE in accordance with splitting the E2E PC5 QoS profile.

7. The method of claim 6, wherein, in accordance with transmitting the first PC5 message, the modified E2E PC5 QoS profile causes the second relay UE to modify one or more QOS parameters associated with a hop between the second relay UE and the first relay UE.

8. The method of claim 6, wherein the second PC5 message further indicates a second per-hop QoS profile between the first relay UE and the second relay UE in accordance with the first PC5 message indicating the modified E2E PC5 QoS profile and the first per-hop QoS profile.

9. The method of claim 1, wherein each hop in the multi-hop network is associated with a respective per-hop QoS profile.

10. A first relay user equipment (UE), comprising:
one or more processors; and
one or more memories coupled with the one or more processors and storing processor-executable code that, when executed by the one or more processors, is configured to cause the first relay UE to:
receive a first message initiating a quality of service (QOS) flow for a remote UE associated with a multi-hop relay network that includes a plurality of UEs including at least the first relay UE, a second relay UE and the remote UE, the multi-hop relay network facilitating communications between the remote UE and a network node;
transmit, to the second relay UE, in accordance with receiving the first message, a first PC5 message indicating an end-to-end (E2E) PC5 QoS profile between the remote UE and the first relay UE, a modified E2E PC5 QoS profile associated with splitting a first per-hop QoS profile between the first relay UE and the second relay UE from the E2E PC5 QoS profile, or the modified E2E PC5 QoS profile and the first per-hop QoS profile between the first relay UE and the second relay UE; and
receive, from the second relay UE, in accordance with transmitting the first PC5 message, a second PC5 message that indicates a confirmation of receiving the first PC5 message.

11. The first relay UE of claim 10, wherein:
the first message is received via the second relay UE in accordance with a PC5 setup procedure or a PC5 modification procedure originating at the remote UE; and
execution of the processor-executable code further causes the first relay UE to:
transmit, to the network node, a second message indicating a hop count associated with the multi-hop network in accordance with receiving the first message; and
receive, from the network node, a third message indicating a QoS mapping in accordance with the hop count.

12. The first relay UE of claim 11, wherein execution of the processor-executable code further causes the first relay UE to determine the E2E PC5 QoS profile in accordance with the QOS mapping.

13. The first relay UE of claim 10, wherein:
the first message is received from the network node;
the first message includes a QoS mapping associated with the multi-hop network; and
execution of the processor-executable code further causes the first relay UE to determine the E2E PC5 QoS profile in accordance with the QoS mapping.

14. The first relay UE of claim 10, wherein execution of the processor-executable code further causes the first relay UE to:
split the E2E PC5 QoS profile; and
determine the modified E2E PC5 QoS profile associated with a path between the second relay UE and the remote UE in accordance with splitting the E2E PC5 QoS profile.

15-24. (canceled)

25. A user equipment (UE), comprising:
one or more processors; and
one or more memories coupled with the one or more processors and storing processor-executable code that, when executed by the one or more processors, is configured to cause the UE to:
receive, from a network node, a reconfiguration message indicating an end-to-end (E2E) PC5 quality of service (QOS) profile for a multi-hop relay network that includes a plurality of UEs including at least the UE and a first relay UE;
transmit, to the first relay UE, in accordance with receiving the reconfiguration message, a first PC5 message indicating the E2E PC5 QoS profile, a modified E2E PC5 QoS profile associated with splitting a first per-hop QoS profile between the UE and the first relay UE from the E2E PC5 QoS profile, or the modified E2E PC5 QoS profile and the first per-hop QoS profile between the UE and the first relay UE; and
receive, from the first relay UE, in accordance with transmitting the first PC5 message, a second PC5 message that indicates a confirmation of receiving the first PC5 message.

26. The UE of claim 25, wherein execution of the processor-executable code further causes the UE to:
split the E2E PC5 QoS profile; and
determining the modified E2E PC5 QoS profile associated with a path between the first relay UE and a remote UE, of the plurality of UEs, or a second relay UE, of the plurality of UEs, in accordance with splitting the E2E PC5 QoS profile.

27. The UE of claim 25, wherein:
the UE is a second relay UE of the plurality of UEs; and
the reconfiguration message also indicates a cellular radio link control (RLC) channel configuration.

28. The UE of claim 25, wherein:
the UE is a remote UE of the plurality of UEs;
the reconfiguration message also indicates an E2E bearer configuration; and
the multi-hop relay network facilitating communications between the remote UE and the network node.

29. The UE of claim 25, wherein:
the reconfiguration message also indicates a per-hop PC5 radio link control (RLC) channel configuration for E2E data radio bearers (DRBs); and
execution of the processor-executable code further causes the UE to transmit, to the first relay UE, a third PC5 message indicating the per-hop PC5 RLC channel configuration for DRBs in accordance with receiving the reconfiguration message.

30. The UE of claim 25, wherein:
the reconfiguration message also indicates a per-hop PC5 radio link control (RLC) channel configuration for E2E signal radio bearers (SRBs); and
execution of the processor-executable code further causes the UE to transmit, to the first relay UE, a third PC5 message indicating the per-hop PC5 RLC channel configuration for SRBs in accordance with receiving the reconfiguration message.
